(19) United States
(12) Patent Application Publication
(10) Pub. No.: US 2024/0396651 A1
(43) Pub. Date: Nov. 28, 2024

(54) CROSS-LINK INTERFERENCE REFERENCE SIGNAL TRANSMISSION AND MEASUREMENTS IN SUBBAND FULL-DUPLEX SCENARIOS

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US)

(21) Appl. No.: 18/670,682

(22) Filed: May 21, 2024

Related U.S. Application Data
(60) Provisional application No. 63/503,683, filed on May 22, 2023.

(51) Int. Cl. H04B 17/345; H04B 17/318; H04L 5/14; H04W 24/10

(52) U.S. Cl. CPC H04B 17/345; H04B 17/328; H04L 5/14; H04W 24/10

(57) ABSTRACT

Methods, systems, and devices for wireless communications are described. The described techniques may allow for a victim user equipment (UE) to perform cross-link interference (CLI) measurements in a guard band. The victim UE may receive a resource configuration from a network entity to perform CLI received strength signal indicator (RSSI) measurements in the guard band resources. Additionally, or alternatively, the victim UE may receive a sounding reference signal (SRS) resource configuration from the network entity to perform CLI reference signal received power (RSRP) measurements in the guard band resources. In such examples, the aggressor UE may receive an SRS resource configuration from the network entity for transmitting SRSs to the victim UE in the guard band resources. The control signaling configuring the SRS resources may indicate, to the aggressor UE, a threshold transmit power, a transmit beam restriction, or both, with which to transmit the SRSs.

### CROSS REFERENCE

The present Application for Patent claims the benefit of U.S. Provisional Patent Application No. 63/503,683 by ABDELGHAFFAR et al., entitled “CROSS-LINK INTERFERENCE REFERENCE SIGNAL TRANSMISSION AND MEASUREMENTS IN SUBBAND FULL-DUPLEX SCENARIOS,” filed May 22, 2023, assigned to the assignee hereof, and expressly incorporated by reference herein.

### TECHNICAL FIELD

The following relates to wireless communications, including cross-link interference reference signal transmission and measurements in subband full-duplex scenarios.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support cross-link interference reference signal transmission and measurements in subband full-duplex scenarios. For example, the described techniques provide for a victim user equipment (UE) to perform cross-link interference (CLI) measurements in a frequency guard band. The victim UE may transmit capability information indicating that the victim UE supports CLI measurements (e.g., CLI reference signal (CLI-RS) measurements) via the guard band, and an aggressor UE may transmit capability information indicating that the aggressor UE supports CLI-RS transmissions via the guard band. The victim UE may receive control signaling (e.g., a resource configuration) from a network entity indicating CLI resources via which to perform CLI received strength signal indicator (RSSI) measurements in the guard band resources. Additionally, or alternatively, the victim UE may receive a sounding reference signal (SRS) resource configuration from the network entity indicating SRS resources via which to perform CLI reference signal received power (RSRP) measurements in the guard band resources. In such examples, the aggressor UE may receive an SRS resource configuration from the network entity for transmitting SRSs via the guard band resources. The control signaling configuring the SRS resources may indicate, to the aggressor UE, a threshold transmit power, a transmit beam restriction, or both, with which to transmit the SRSs, which may reduce or limit the interference caused by transmission of the SRSs via the guard band.

A method for wireless communications at a UE is described. The method may include transmitting capability information indicating that the UE is capable of performing CLI measurements via a guard band located between an uplink subband and a downlink subband during at least one time period allocated for a subband full duplex operation, receiving, based on transmitting the capability information, control signaling indicating one or more resources for measuring CLI from at least a second UE, the one or more resources at least partially overlapping in frequency with the guard band, performing one or more CLI measurements via the one or more resources, and transmitting a CLI measurement report based on the one or more CLI measurements.

An apparatus for wireless communications at a UE is described. The apparatus may include at least one processor, at least one memory coupled (e.g., operatively, communicatively, functionally, electronically, or electrically) with the at least one processor, and instructions stored in the at least one memory. The instructions may be executable by the at least one processor (e.g., directly, indirectly, after pre-processing, without pre-processing) to cause the UE to transmit capability information indicating that the UE is capable of performing CLI measurements via a guard band located between an uplink subband and a downlink subband during at least one time period allocated for a subband full duplex operation, receive, based on transmitting the capability information, control signaling indicating one or more resources for measuring CLI from at least a second UE, the one or more resources at least partially overlapping in frequency with the guard band, perform one or more CLI measurements via the one or more resources, and transmit a CLI measurement report based on the one or more CLI measurements.

Another apparatus for wireless communications at a UE is described. The apparatus may include means for transmitting capability information indicating that the UE is capable of performing CLI measurements via a guard band located between an uplink subband and a downlink subband during at least one time period allocated for a subband full duplex operation, means for receiving, based on transmitting the capability information, control signaling indicating one or more resources for measuring CLI from at least a second UE, the one or more resources at least partially overlapping in frequency with the guard band, means for performing one or more CLI measurements via the one or more resources, and means for transmitting a CLI measurement report based on the one or more CLI measurements.

A non-transitory computer-readable medium storing code for wireless communications at a UE is described. The code may include instructions executable by at least one processor (e.g., directly, indirectly, after pre-processing, without pre-processing) to transmit capability information indicating that the UE is capable of performing CLI measurements via a guard band located between an uplink subband and a downlink subband during at least one time period allocated for a subband full duplex operation, receive, based on transmitting the capability information, control signaling indicating one or more resources for measuring CLI from at least a second UE, the one or more resources at least partially overlapping in frequency with the guard band, perform one or more CLI measurements via the one or more resources, and transmit a CLI measurement report based on the one or more CLI measurements.

Some examples of the method, apparatuses, and non-transitory computer-readable medium described herein may further include operations, features, means, or instructions for receiving, via the control signaling, an indication that the one or more resources at least partially overlap with the uplink subband, the downlink subband, or both.

Some examples of the method, apparatuses, and non-transitory computer-readable medium described herein may further include operations, features, means, or instructions for receiving, via the control signaling, an indication that the one or more resources do not overlap with the uplink subband or the downlink subband.

In some examples of the method, apparatuses, and non-transitory computer-readable medium described herein, performing the one or more CLI measurements may include operations, features, means, or instructions for measuring a CLI-RSSI via the one or more resources based on the capability.

Some examples of the method, apparatuses, and non-transitory computer-readable medium described herein may further include operations, features, means, or instructions for receiving, via the control signaling, an indication of a set of multiple SRS resources including the one or more resources based on the capability, monitoring for one or more SRSs from at least the second UE via the set of multiple SRS resources, and measuring CLI-RSRP via the one or more resources based on the monitoring.

In some examples of the method, apparatuses, and non-transitory computer-readable medium described herein, the set of multiple SRS resources correspond to a communication SRS configuration, or a positioning SRS configuration, the one or more resources including a subset of the set of multiple SRS resources.

In some examples of the method, apparatuses, and non-transitory computer-readable medium described herein, the set of multiple SRS resources may be allocated for the one or more CLI measurements.

A method for wireless communications at a UE is described. The method may include transmitting capability information indicating that the UE is capable of transmitting CLI-RSs via a guard band located between an uplink subband and a downlink subband during at least one time period allocated for a subband full duplex operation, receiving, based on transmitting the capability information, control signaling indicating one or more resources for transmitting the CLI-RSs, the one or more resources at least partially overlapping in frequency with the guard band, and transmitting the CLI-RSs via the one or more resources based on receiving the control signaling indicating the one or more resources.

An apparatus for wireless communications at a UE is described. The apparatus may include at least one processor, at least one memory coupled (e.g., operatively, communicatively, functionally, electronically, or electrically) with the at least one processor, and instructions stored in the at least one memory. The instructions may be executable by the at least one processor (e.g., directly, indirectly, after pre-processing, without pre-processing) to cause the UE to transmit capability information indicating that the UE is capable of transmitting CLI-RSs via a guard band located between an uplink subband and a downlink subband during at least one time period allocated for a subband full duplex operation, receive, based on transmitting the capability information, control signaling indicating one or more resources for transmitting the CLI-RSs, the one or more resources at least partially overlapping in frequency with the guard band, and transmit the CLI-RSs via the one or more resources based on receiving the control signaling indicating the one or more resources.

Another apparatus for wireless communications at a UE is described. The apparatus may include means for transmitting capability information indicating that the UE is capable of transmitting CLI-RSs via a guard band located between an uplink subband and a downlink subband during at least one time period allocated for a subband full duplex operation, means for receiving, based on transmitting the capability information, control signaling indicating one or more resources for transmitting the CLI-RSs, the one or more resources at least partially overlapping in frequency with the guard band, and means for transmitting the CLI-RSs via the one or more resources based on receiving the control signaling indicating the one or more resources.

A non-transitory computer-readable medium storing code for wireless communications at a UE is described. The code may include instructions executable by at least one processor (e.g., directly, indirectly, after pre-processing, without pre-processing) to transmit capability information indicating that the UE is capable of transmitting CLI-RSs via a guard band located between an uplink subband and a downlink subband during at least one time period allocated for a subband full duplex operation, receive, based on transmitting the capability information, control signaling indicating one or more resources for transmitting the CLI-RSs, the one or more resources at least partially overlapping in frequency with the guard band, and transmit the CLI-RSs via the one or more resources based on receiving the control signaling indicating the one or more resources.

Some examples of the method, apparatuses, and non-transitory computer-readable medium described herein may further include operations, features, means, or instructions for receiving, via the control signaling, an indication of a threshold transmit power, a transmit beam restriction, or both, where transmitting the CLI-RSs includes transmitting the CLI-RSs according to the threshold transmit power, via the transmit beam, or both.

Some examples of the method, apparatuses, and non-transitory computer-readable medium described herein may further include operations, features, means, or instructions for receiving, via the control signaling, an indication of a set of multiple SRS resources including the one or more resources, where the CLI-RSs include SRSs.

In some examples of the method, apparatuses, and non-transitory computer-readable medium described herein, the set of multiple SRS resources correspond to a communication SRS configuration, or a positioning SRS configuration, the one or more resources including a subset of the set of multiple SRS resources.

In some examples of the method, apparatuses, and non-transitory computer-readable medium described herein, the set of multiple SRS resources may be allocated for CLI measurements.

Some examples of the method, apparatuses, and non-transitory computer-readable medium described herein may further include operations, features, means, or instructions for receiving, via the control signaling, an indication that the one or more resources at least partially overlap with the uplink subband.

Some examples of the method, apparatuses, and non-transitory computer-readable medium described herein may further include operations, features, means, or instructions for receiving, via the control signaling, an indication that the one or more resources do not overlap with the uplink subband or the downlink subband.

A method for wireless communications at a network entity is described. The method may include receiving, from a set of multiple UEs, capability information indicating a capability to support CLI measurements via a guard band located between an uplink subband and a downlink subband during at least one time period allocated for a subband full duplex operation, transmitting, based on receiving the capability information, control signaling indicating one or more resources for CLI measurement, the one or more resources at least partially overlapping in frequency with the guard band, and receiving, from at least a first UE of the set of multiple UEs, a CLI measurement report.

An apparatus for wireless communications at a network entity is described. The apparatus may include at least one processor, at least one memory coupled (e.g., operatively, communicatively, functionally, electronically, or electrically) with the at least one processor, and instructions stored in the at least one memory. The instructions may be executable by the at least one processor (e.g., directly, indirectly, after pre-processing, without pre-processing) to cause the network entity to receive, from a set of multiple UEs, capability information indicating a capability to support CLI measurements via a guard band located between an uplink subband and a downlink subband during at least one time period allocated for a subband full duplex operation, transmit, based on receiving the capability information, control signaling indicating one or more resources for CLI measurement, the one or more resources at least partially overlapping in frequency with the guard band, and receive, from at least a first UE of the set of multiple UEs, a CLI measurement report.

Another apparatus for wireless communications at a network entity is described. The apparatus may include means for receiving, from a set of multiple UEs, capability information indicating a capability to support CLI measurements via a guard band located between an uplink subband and a downlink subband during at least one time period allocated for a subband full duplex operation, means for transmitting, based on receiving the capability information, control signaling indicating one or more resources for CLI measurement, the one or more resources at least partially overlapping in frequency with the guard band, and means for receiving, from at least a first UE of the set of multiple UEs, a CLI measurement report.

A non-transitory computer-readable medium storing code for wireless communications at a network entity is described. The code may include instructions executable by at least one processor (e.g., directly, indirectly, after pre-processing, without pre-processing) to receive, from a set of multiple UEs, capability information indicating a capability to support CLI measurements via a guard band located between an uplink subband and a downlink subband during at least one time period allocated for a subband full duplex operation, transmit, based on receiving the capability information, control signaling indicating one or more resources for CLI measurement, the one or more resources at least partially overlapping in frequency with the guard band, and receive, from at least a first UE of the set of multiple UEs, a CLI measurement report.

In some examples of the method, apparatuses, and non-transitory computer-readable medium described herein, receiving the capability information may include operations, features, means, or instructions for receiving the capability information from the first UE, the capability information including an indication that the first UE may be capable of performing CLI measurements via the guard band.

In some examples of the method, apparatuses, and non-transitory computer-readable medium described herein, receiving the capability information may include operations, features, means, or instructions for receiving the capability information from a second UE, the capability information including an indication that the second UE may be capable of transmitting CLI-RSs via the guard band.

Some examples of the method, apparatuses, and non-transitory computer-readable medium described herein may further include operations, features, means, or instructions for transmitting, to the second UE via the control signaling based on the capability information, an indication of a threshold transmit power, a transmit beam restriction, or both.

Some examples of the method, apparatuses, and non-transitory computer-readable medium described herein may further include operations, features, means, or instructions for transmitting, via the control signaling, an indication of a set of multiple SRS resources including the one or more resources.

In some examples of the method, apparatuses, and non-transitory computer-readable medium described herein, the set of multiple SRS resources correspond to a communication SRS configuration, or a positioning SRS configuration, the one or more resources including a subset of the set of multiple SRS resources.

In some examples of the method, apparatuses, and non-transitory computer-readable medium described herein, the set of multiple SRS resources may be allocated for CLI measurements.

Some examples of the method, apparatuses, and non-transitory computer-readable medium described herein may further include operations, features, means, or instructions for transmitting, via the control signaling, an indication that the one or more resources at least partially overlap with the uplink subband.

Some examples of the method, apparatuses, and non-transitory computer-readable medium described herein may further include operations, features, means, or instructions for transmitting, via the control signaling, an indication that the one or more resources do not overlap with the uplink subband or the downlink subband.

### BRIEF DESCRIPTION OF THE DRAWINGS

FIG. 1 shows an example of a wireless communications system that supports cross-link interference (CLI) reference signal transmission and measurements in subband full-duplex scenarios in accordance with one or more aspects of the present disclosure.

FIG. 2 shows an example of a wireless communications system that supports CLI reference signal transmission and measurements in SBFD scenarios in accordance with one or more aspects of the present disclosure.

FIG. 3 shows an example of a resource diagram that supports CLI reference signal transmission and measurements in SBFD scenarios in accordance with one or more aspects of the present disclosure.

FIG. 4 shows an example of a process flow that supports CLI reference signal transmission and measurements in SBFD scenarios in accordance with one or more aspects of the present disclosure.

FIGS. 5 and 6 show block diagrams of devices that support CLI reference signal transmission and measurements in SBFD scenarios in accordance with one or more aspects of the present disclosure.

FIG. 7 shows a block diagram of a communications manager that supports CLI reference signal transmission and measurements in SBFD scenarios in accordance with one or more aspects of the present disclosure.

FIG. 8 shows a diagram of a system including a device that supports CLI reference signal transmission and measurements in SBFD scenarios in accordance with one or more aspects of the present disclosure.

FIGS. 9 and 10 show block diagrams of devices that support CLI reference signal transmission and measurements in SBFD scenarios in accordance with one or more aspects of the present disclosure.

FIG. 11 shows a block diagram of a communications manager that supports CLI reference signal transmission and measurements in SBFD scenarios in accordance with one or more aspects of the present disclosure.

FIG. 12 shows a diagram of a system including a device that supports CLI reference signal transmission and measurements in SBFD scenarios in accordance with one or more aspects of the present disclosure.

FIGS. 13 through 18 show flowcharts illustrating methods that support CLI reference signal transmission and measurements in SBFD scenarios in accordance with one or more aspects of the present disclosure.

### DETAILED DESCRIPTION

In some wireless communications systems, a network entity may communicate with one or more user equipment (UEs) using subband full-duplex (SBFD) communications. That is, the network entity may configure a UE to simultaneously receive downlink signaling and transmit uplink signaling. In such systems, a frequency subband used for uplink communications may be separated from a frequency subband used for downlink communications by a frequency guard band. The frequency guard band may be configured to reduce interference between the uplink subband and the downlink subband.

In some examples, an aggressor UE communicating uplink or downlink signaling with the network entity may generate interference (e.g., cross-link interference (CLI)) at a victim UE performing SBFD communications. For instance, the victim UE may monitor for and receive downlink signaling while the aggressor UE is transmitting uplink signaling, in which case the uplink signaling from the aggressor UE may cause interference with the downlink signaling (e.g., the victim UE monitoring for the downlink signaling may detect the uplink signaling transmitted by the aggressor UE). The victim UE may perform CLI measurements (e.g., received signal strength indication (RSSI) or reference signal received power (RSRP) measurements) in CLI measurement resources configured by the network entity. The network may utilize CLI measurements to identify and mitigate or avoid communications that result in too much CLI, degrading reliability of communications.

In SBFD scenarios, guard bands may be allocated to remain unoccupied. However, if UEs refrain from utilizing the guard band entirely, then system efficiency may decrease, system latency may increase, and user experience may be decreased. However, if the victim UE performs CLI measurements via the frequency guard band, interference may increase at the network entity or at other UEs in communication with the network entity (e.g., transmission of CLI-RSs via the guard band may result in increased interference in the uplink subband or the downlink subband).

Accordingly, techniques described herein may allow for the victim UE to perform CLI measurements via the frequency guard band. For example, a victim UE may transmit capability information indicating that the victim UE supports CLI measurements (e.g., CLI reference signal (CLI-RS) measurements) via the guard band, and an aggressor UE may transmit capability information indicating that the aggressor UE supports CLI-RS transmissions via the guard band. The victim UE may receive control signaling (e.g., a resource configuration) from a network entity indicating CLI resources via which to perform CLI-RSSI measurements via the guard band resources. In such examples, the victim UE may perform CLI-RSSI measurements via the guard band resources; via both the guard band and uplink subband resources; or via the guard band, uplink subband, and downlink subband resources. Additionally, or alternatively, the victim UE may receive a resource configuration from the network entity indicating sounding reference signal (SRS) resources via which to perform CLI-RSRP measurements via the guard band resources. In such examples, the aggressor UE may receive a sounding reference signal (SRS) resource configuration from the network entity for transmitting SRSs via the guard band resources (e.g., and the uplink frequency subband). The control signaling configuring the SRS resources may indicate, to the aggressor UE, a threshold transmit power, a transmit beam restriction, or both, with which to transmit the SRSs, which may reduce or limit the interference caused by transmission of the SRSs via the guard band.

Aspects of the disclosure are initially described in the context of wireless communications systems. Aspects of the disclosure are further illustrated by and described with reference to resource diagrams and process flow diagrams. Aspects of the disclosure are further illustrated by and described with reference to apparatus diagrams, system diagrams, and flowcharts that relate to CLI reference signal transmission and measurements in SBFD scenarios.

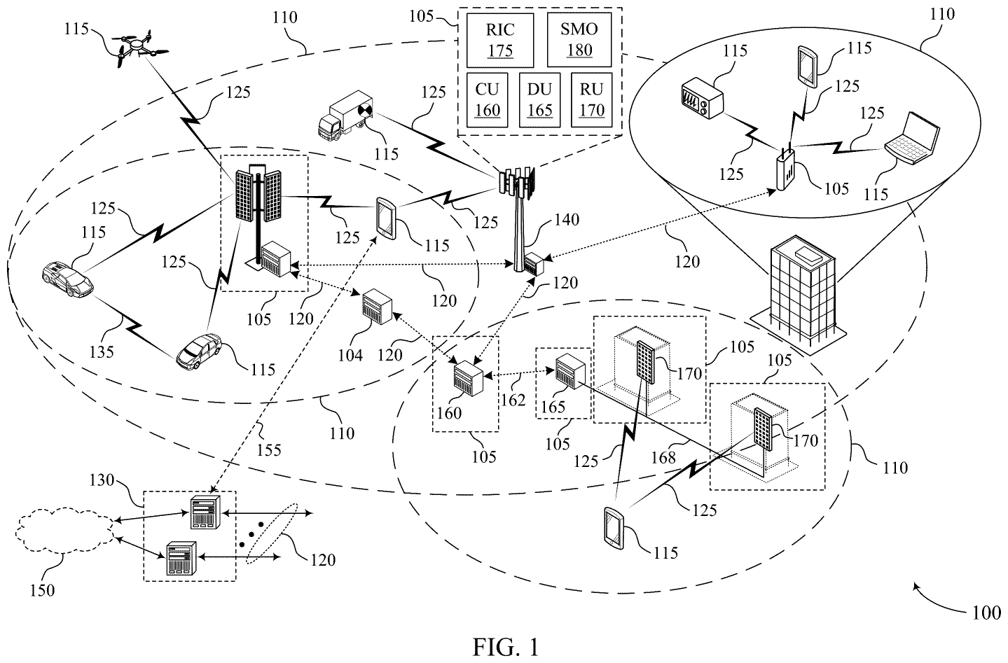

FIG. 1 shows an example of a wireless communications system 100 that supports CLI reference signal transmission and measurements in SBFD scenarios in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support CLI reference signal transmission and measurements in SBFD scenarios as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Techniques described herein may allow for a victim UE 115 to perform CLI measurements via a frequency guard band. For example, the victim UE 115 may transmit capability information indicating that the victim UE 115 supports CLI measurements (e.g., CLI-RS measurements) via the guard band, and an aggressor UE 115 may transmit capability information indicating that the aggressor UE 115 supports CLI-RS transmissions via the guard band. The victim UE 115 may receive a resource configuration from a network entity 105 to perform CLI-RSSI measurements via the guard band resources. In such examples, the victim UE 115 may perform CLI-RSSI measurements via the guard band resources; via both the guard band and uplink subband resources; or via the guard band, the uplink subband, and downlink subband resources. Additionally, or alternatively, the victim UE 115 may receive an SRS resource configuration from the network entity 105 to perform CLI-RSRP measurements via the guard band resources. In such examples, the aggressor UE 115 may receive an SRS resource configuration from the network entity 105 for transmitting SRSs to the victim UE 115 via the guard band resources (e.g., and the uplink frequency subband). The control signaling configuring the SRS resources may indicate, to the aggressor UE 115, a threshold transmit power, a transmit beam restriction, or both, with which to transmit the SRSs, which may reduce or limit the interference caused by transmission of the SRSs via the guard band.

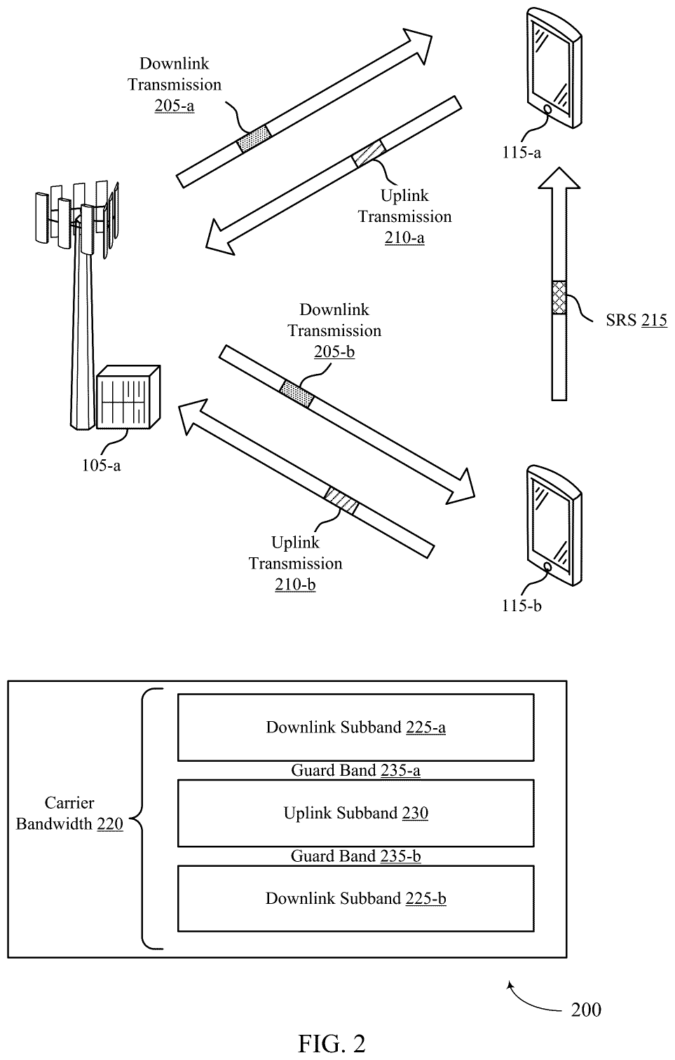

FIG. 2 shows an example of a wireless communications system 200 that supports CLI reference signal transmission and measurements in SBFD scenarios in accordance with one or more aspects of the present disclosure. The wireless communications system 200 may implement aspects of or may be implemented by aspects of the wireless communications system 100. For example, the wireless communications system 200 may include one or more UEs 115 (e.g., a UE 115-a and a UE 115-b) and one or more network entities 105 (e.g., a network entity 105-a), which may be examples of the corresponding devices as described with reference to FIG. 1.

In some wireless communications systems, a network entity 105-a may communicate with a UE 115-a (e.g., a victim UE 115-a) and a UE 115-b (e.g., an aggressor UE 115-b) using SBFD communications (e.g., during one or more SBFD time periods, such as one or more SBFD slots or SBFD symbols). That is, the network entity 105-a, the UE 115-a, and the UE 115-b may communicate downlink transmissions 205 and uplink transmissions 210 via shared time resources (e.g., via one or more downlink subbands 225 and one or more uplink subbands 230 that at least partially overlap in time). For example, the network entity 105-a may transmit a downlink transmission 205-a to the UE 115-a via a downlink subband 225-a or a downlink subband 225-b in a carrier bandwidth 220. The network entity 105-a may receive an uplink transmission 210-a from the UE 115-a via an uplink subband 230 in the carrier bandwidth 220. Similarly, the network entity 105-a may transmit a downlink transmission 205-b to the UE 115-b via the downlink subband 225-a or the downlink subband 225-b, and may receive an uplink transmission 210-b from the UE 115-b via the uplink subband 230. In such systems, to prevent interference between the uplink subband 230 and the downlink subbands 225, the downlink subband 225-a and the downlink subband 225-b may be separated from the uplink subband 230 by a guard band 235-a and a guard band 235-b, respectively.

The UE 115-a and the UE 115-b may determine frequency location information for the guard band 235-a and the guard band 235-b in the SBFD symbols of the carrier bandwidth 220 via control signaling, such as semi-static signaling (e.g., radio resource control (RRC) signaling). In some examples, the network entity 105-a may configure the UE 115-a and the UE 115-b with frequency location configuration information for the downlink subband 225-a and the downlink subband 225-b (e.g., explicitly). In such examples, the UE 115-a and the UE 115-b may determine (e.g., implicitly derive) frequency location configuration information for the guard band 235-a and the guard band 235-b as resource blocks (RBs) which are not within the uplink subband 230, the downlink subband 225-a, or the downlink subband 225-b. In some examples, the network entity 105-a may configure the UE 115-a and the UE 115-b with frequency location information for the guard band 235-a and the guard band 235-b (e.g., explicitly). In such examples, the UE 115-a and the UE 115-b may determine (e.g., implicitly derive) frequency location information for the downlink subband 225-a and the downlink subband 225-b as RBs which are not within the uplink subband 230, the guard band 235-a, or the guard band 235-b. The UE 115-a and the UE 115-b may accordingly refrain from communicating uplink transmissions 210 or monitoring for downlink transmissions 205 via the guard band 235-a and the guard band 235-b. However, as described herein, the UE 115-a and the UE 115-b may perform measurements in the guard band 235-a or the guard band 235-b.

In some examples, the UE 115-b (e.g., the aggressor UE 115-b) may cause interference (e.g., CLI) at the UE 115-a performing SBFD communications (e.g., the victim UE 115-a) by transmitting uplink transmissions 210 or receiving downlink transmissions 205 (e.g., which may be sensed by the UE 115-a while monitoring for downlink signaling from the network entity 105-a). Accordingly, the victim UE 115-a may perform CLI measurements (e.g., CLI-RSSI or CLI-RSRP measurements) via the uplink subband 230, the downlink subband 225-a, and/or the downlink subband 225-b. For example, the victim UE 115-a may perform RSSI-based CLI measurements via the uplink subband 230, the downlink subband 225-a, and/or the downlink subband 225-b using any transmission from the aggressor UE 115-b. Additionally, or alternatively, the victim UE 115-a may perform RSRP-based CLI measurements via the uplink subband 230 using SRSs 215 from the aggressor UE 115-b (e.g., when the uplink subband 230 is confined within an active downlink BWP of the UE 115-a and the UE 115-b). The victim UE 115-a may report the CLI measurements to the network entity 105-a such that the network entity 105-a may adjust the guard band 235-a and the guard band 235-b to mitigate interference from the aggressor UE 115-b. Additionally, or alternatively, the victim UE 115-a may use the CLI measurements to block CLI from the aggressor UE 115-b.

In some examples, as described herein, UEs 115 may support CLI-RS transmission and CLI measurements via one or more guard bands 235. For example, the victim UE 115-a may perform CLI measurements via the frequency guard band 235-a and/or the frequency guard band 235-b (e.g., when the frequency guard band 235-a and the frequency guard band 235-b are confined within the active downlink BWP of the UE 115-a and the UE 115-b). The victim UE 115-a may perform guard band CLI measurements to report a finer granularity of CLI to the network entity 105-a (e.g., such that the network entity 105-a may more accurately determine an effective size of the guard band 235-a and the guard band 235-b). That is, in some examples (e.g., if requesting of size and/or frequency resources of the guard band 235-a and the guard band 235-b by the victim UE 115-a is supported), the CLI measurement information may be used by the network entity 105-a to adjust the size and/or frequency resources of the guard band 235-a and the guard band 235-b for each UE 115 in communication with the network entity 105-a (e.g., the network may decrease the size of the guard bands 235 if CLI measurements are relatively low or are less than a threshold, or may increase the size of the guard bands 235 if CLI measurements are relatively high or exceed a threshold) or adjust the transmission parameters and frequency resources for the aggressor UE 115-b. Additionally, or alternatively, guard band CLI measurements may allow for the victim UE 115-a to block CLI from the aggressor UE 115-b more effectively. Guard band CLI measurements may additionally allow for more efficient use of frequency resources (e.g., due to use of resources in the frequency spectrum which may not be used for uplink transmissions 210 or downlink transmissions 205).

In some cases, if the victim UE 115-a performs CLI measurements via the guard band 235-a and the guard band 235-b, interference may increase at the network entity 105-a or at other UEs 115 in communication with the network entity 105-a due to reduced unused frequency resources in the carrier bandwidth 220. That is, the network entity 105-a may experience increased interference in receiving uplink transmissions 210 as a result of reduced separation between uplink and downlink resources. Additionally, guard band CLI measurements may increase CLI between the victim UE 115-a and the other UEs 115 receiving downlink transmissions from the network entity 105-a due to reduced RB separation.

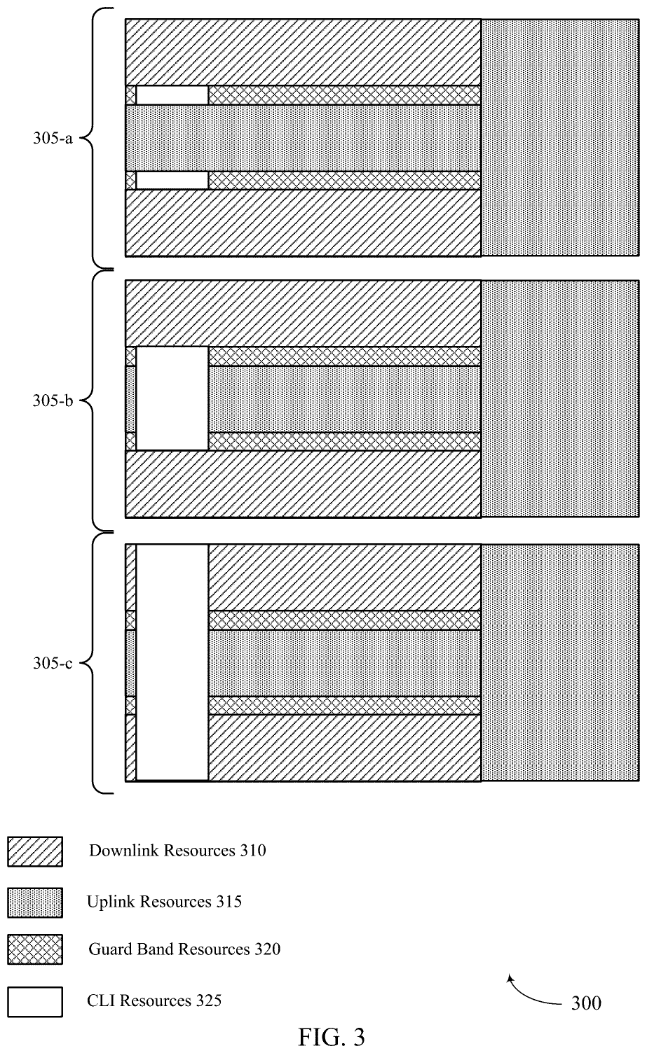

Accordingly, techniques described herein may allow for the victim UE 115-a to perform CLI measurements via the guard band 235-a and the guard band 235-b. For example, the victim UE 115-a may receive a resource configuration from the network entity 105-a to perform CLI-RSSI measurements via the guard band resources. The resource configuration may additionally allow the victim UE 115-a to perform CLI-RSSI measurements via some or all of the uplink resources, the downlink resources, or both. That is, the victim UE 115-a may perform CLI-RSSI measurements via the guard band 235-a and the guard band 235-b; via the guard band 235-a, the guard band 235-b, and the uplink subband 230; or via the guard band 235-b, the guard band 235-a, the guard band 235-b, the uplink subband 230, the downlink subband 225-a, and the downlink subband 225-b, as described in greater detail with reference to FIG. 3.

Additionally, or alternatively, the victim UE 115-a may receive a resource configuration from the network entity 105-a to perform CLI-RSRP measurements via the guard band resources. The resource configuration may additionally allow the victim UE 115-a to perform CLI-RSRP measurements via some or all of the uplink resources. That is, the victim UE 115-a may perform CLI-RSRP measurements via the guard band 235-a and the guard band 235-b, or via the guard band 235-a, the guard band 235-b, and the uplink subband 230. In such examples, the aggressor UE 115-b may receive an SRS resource configuration from the network entity 105-a for transmitting SRSs 215 to the victim UE 115-a via the guard band resources (e.g., and the uplink resources). Control signaling configuring the SRS resources may indicate, to the aggressor UE 115, a threshold transmit power, a transmit beam, or both, on which to transmit the SRSs 215, which may reduce or limit the interference caused by transmission of the SRSs 215 via the guard band 235-a and the guard band 235-b.

The network entity 105-a may transmit the resource configurations based on receiving capability messages from the victim UE 115-a and the aggressor UE 115-b. For example, the victim UE 115-a may transmit a capability message indicating a capability of the victim UE 115-a to perform CLI measurements (e.g., CLI-RSSI measurements, CLI-RSRP measurements, or both) via the guard band resources. The aggressor UE 115-b may transmit a capability message indicating a capability of the aggressor UE 115-b to transmit reference signals (e.g., SRSs) via the guard band resources.

FIG. 3 shows an example of a resource diagram 300 that supports CLI reference signal transmission and measurements in SBFD scenarios in accordance with one or more aspects of the present disclosure. The resource diagram 300 may implement aspects of or may be implemented by aspects of the wireless communications system 100 or the wireless communications system 200. For example, a UE 115 (e.g., a victim UE 115 and/or an aggressor UE 115) and a network entity 105, which may be examples of the corresponding devices as described with reference to FIG. 1, may communicate according to the resource diagram 300.

In some implementations, a network entity 105 may configure a victim UE 115 with an CLI measurement scenario 305 for performing guard band CLI-RSSI measurements, such as an CLI measurement scenario 305-a, an CLI measurement scenario 305-b, or an CLI measurement scenario 305-c. For example, the network entity 105 may configure the victim UE 115 with a CLI measurement resource 325 in guard band resources 320 for the victim UE 115 to perform CLI-RSSI measurements. In some examples, the network entity 105 may configure the victim UE 115 with the CLI measurement resource 325 in the guard band resources 320 (e.g., exclusively), as illustrated with reference to the CLI measurement scenario 305-a. In some examples, the network entity 105-a may configure the victim UE 115 with the CLI measurement resource 325 in the guard band resources 320 and in uplink resources 315, as illustrated with reference to the CLI measurement scenario 305-b. In some examples, the network entity 105-a may configure the victim UE 115 with the CLI measurement resource 325 in the guard band resources 320, in the uplink resources 315, and in downlink resources 310, as illustrated in the CLI measurement scenario 305-c. When the CLI-RSSI measurements are configured in the guard band, the victim UE 115 may not be expected (e.g., configured) to measure CLI-RSRP in the guard band. Similarly, the victim UE 115 and the aggressor UE 115 may not be configured with SRS resources in the guard band (e.g., either that overlap with the guard band or configured explicitly in the guard band). That is, the network may refrain from configuring SRS resources in the guard band because the UE 115 may measure RSSI in the guard band (e.g., without any need to measure RSRP via SRSs in the guard band).

In some examples, the victim UE 115 may perform CLI-RSRP measurements in addition to the CLI-RSSI measurements via the CLI measurement resource 325. In some examples, the victim UE 115 may refrain from performing CLI-RSRP measurements via the CLI measurement resource. That is, the victim UE 115 may not expect to receive a configuration from the network entity 105 to receive SRSs from an aggressor UE 115 (e.g., and thus to perform CLI-RSRP measurements) via the guard band resources 320 or via resources overlapping with the guard band resources 320 (e.g. in resources partially or fully overlapping with the guard band resources 320 or resources configured explicitly in the guard band resources 320). In such examples, the aggressor UE 115 may transmit signaling via the uplink resources 315 (e.g., rather than the guard band resources 320). The victim UE 115 may perform CLI-RSSI measurements on signal leakage via the guard band resources 320 (e.g., and the uplink resources 315 and/or the downlink resources 310).

In some examples, the victim UE 115 may transmit a capability message to the network entity 105 indicating a capability of the victim UE 115 to perform CLI measurements (e.g., CLI-RSSI measurements, CLI-RSRP measurements, or both) via the guard band resources 320. For example, the capability message may indicate if the victim UE 115 has a subband frequency filter which prevents the victim UE 115 from measuring or receiving reference signals via the guard band resources 320 (e.g., a strict filter or a notch filter).

In some implementations, a network entity 105 may configure a victim UE 115 with an CLI measurement scenario 305 for performing guard band CLI-RSRP measurements, such as an CLI measurement scenario 305-a or an CLI measurement scenario 305-b. For example, the network entity 105 may configure the victim UE 115 with a CLI measurement resource 325 (e.g., an SRS resource) in guard band resources 320 for the victim UE 115 to perform CLI-RSRP measurements on SRSs from an aggressor UE 115. In some examples, the network entity 105 may configure the victim UE 115 with the CLI measurement resource 325 in the guard band resources 320 in an active downlink BWP (e.g., exclusively), as illustrated in the CLI measurement scenario 305-a. In some examples, the network entity 105-a may configure the victim UE 115 with the CLI measurement resource 325 in the guard band resources 320 and in uplink resources 315 in the active downlink BWP, as illustrated in the CLI measurement scenario 305-b. In some examples, the network entity 105-a may configure the victim UE 115 with the CLI measurement resource 325 in the uplink resources 315. In some examples, the victim UE 115 may perform CLI-RSSI measurements in addition to the CLI-RSRP measurements via the CLI measurement resource 325.

The victim UE 115 may perform SRS-RSRP measurements or CLI-RSSI measurements across a frequency band (e.g., in wideband resources) or in a portion of the frequency band (e.g., in subband resources). For example, the UE 115 may perform wideband or subband measurements. In some examples, the victim UE 115 may transmit a capability message to the network entity 105 indicating a capability of the victim UE 115 to perform CLI measurements (e.g., CLI-RSSI measurements, CLI-RSRP measurements, or both) via the guard band resources 320. For example, the capability message may indicate if the victim UE 115 has a subband frequency filter which prevents the victim UE 115 from measuring or receiving reference signals via the guard band resources 320 (e.g., a strict filter or a notch filter). The network entity 105 may configure the victim UE 115 with the SRS resource based at least in part on the capability.

In some implementations, a network entity 105 may configure an aggressor UE 115 (e.g., an SBFD-aware UE 115) with an CLI measurement scenario 305 (e.g., may configure the UE 115 with a set of SRS resources) for performing SRS transmissions to a victim UE 115, such as an CLI measurement scenario 305-a or an CLI measurement scenario 305-b. For example, the network entity 105 may configure the aggressor UE 115 to transmit SRSs via a CLI measurement resource 325 in guard band resources 320 (e.g., such that the victim UE 115 may perform guard band CLI-RSRP measurements).

In some aspects, the network entity 105 may configure the aggressor UE 115 to transmit the SRSs in the CLI measurement resource 325 in the guard band resources 320 in an active downlink BWP (e.g., exclusively), as illustrated in the CLI measurement scenario 305-a. For example, the network entity 105 may configure the aggressor UE 115 to transmit the SRSs in one of the guard bands or in both guard bands. In some examples (e.g., if frequency hopping is disabled), each guard band resource 320 may be configured as a separate (e.g., single) SRS resource each associated with a same SRS resource set. In some examples (e.g., if frequency hopping is enabled), both guard band resources 320 may be a same SRS resource (e.g., with a frequency hop). In such examples, frequency hopping may be enabled (e.g., valid) within the guard band resources 320 (e.g., and disabled outside of the guard band resources 320).

In some aspects, the network entity 105-a may configure the aggressor UE 115 to transmit the SRSs via the CLI measurement resource 325 in the guard band resources 320 and in uplink resources 315 in the active downlink BWP, as illustrated in the CLI measurement scenario 305-b. In some examples, the network entity 105-a may configure the aggressor UE 115 to transmit the SRSs via the CLI measurement resource 325 via the uplink resources 315.

In such implementations, the aggressor UE 115 may transmit a capability message to the network entity 105 indicating a capability of the aggressor UE 115 to transmit SRSs via the guard band resources 320. For example, the capability message may indicate if the aggressor UE 115 has a subband transmission filter (e.g., to reduce emissions such as in-band emissions (IBE)) or if the aggressor UE 115 is configured to use guard band resources 320 for other purposes (e.g., to optimize an RF front end (RFFE) of the aggressor UE 115). In such examples, the aggressor UE 115 may not transmit reference signals via the guard band resources 320.

Additionally, or alternatively, the network entity 105 may configure the aggressor UE 115 (e.g., explicitly) to transmit the SRSs using a transmit power which may not exceed a threshold (e.g., a configured threshold). Additionally, or alternatively, the network entity 105 may configure the aggressor UE 115 (e.g., explicitly) to transmit the SRSs using a specified beam (e.g., in a specified beam direction) or with a transmit beam restriction (e.g., may indicate one or more beams that are preferred or permitted for transmission of CLI-RSs such as SRSs, or one or more beams that are non-preferred or not allowed for transmission of CLI-RSs such as SRSs).

The network entity 105 may configure the UE with one or more SRSs resources, which may be dedicated SRS resources for CLI measurements, or may be a subset of SRS resources (e.g., positioning SRS resources or communication resources such as MIMO resources). In some examples, the network entity 105 may configure the aggressor UE 115 to transmit a first type of SRSs which may be specific to CLI measurements (e.g., CLI SRSs configured with an SRS usage set such as SRS-CLI). Such CLI SRSs may not be received by the network entity 105. In some examples, the network entity 105 may configure the aggressor UE 115 to transmit a second type of SRSs which may be a subset of one or more SRS resources (e.g., may be reused or repurposed SRS resources), such as communication SRSs (e.g., codebook based, non-codebook based, antenna switching, or beam management SRSs) configured with an SRS usage set such as SRS-MIMO or positioning SRSs configured with an SRS usage set such as SRS-POS. In such examples, the network entity 105 may configure the aggressor UE 115 to transmit the second type of SRSs, and may indicate one or more SRSs (e.g., one or more SRSs of an SRS set of one or more SRS sets) for the aggressor UE 115 to transmit as CLI-RSs.

In some examples, the aggressor UE 115 may generate the SRSs according to a sequence defined in a rule (e.g., a rule defined by a wireless communications standard). For example, the aggressor UE may generate a multiple of 6 SRSs (e.g., without SRS truncation).

In some examples, the aggressor UE 115 may not be configured to (e.g., expected to) transmit uplink signaling via frequency resources outside of the uplink resources 315. In such examples, the aggressor UE 115 may transmit SRSs for CLI measurements via frequency resources outside of the uplink resources 315.

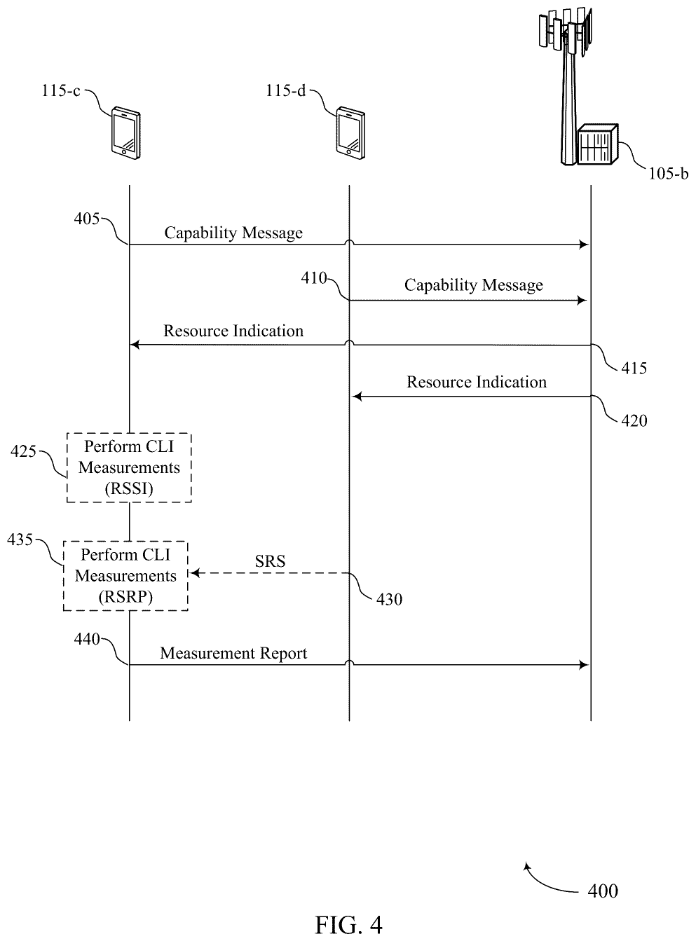

FIG. 4 shows an example of a process flow 400 that supports CLI reference signal transmission and measurements in SBFD scenarios in accordance with one or more aspects of the present disclosure. The process flow 400 may implement aspects of or may be implemented by aspects of the wireless communications system 100, the wireless communications system 200, or the resource diagram 300. For example, the process flow 400 may include a UE 115 (e.g., a UE 115-c and a UE 115-d) and a network entity 105 (e.g., a network entity 105-b), which may be examples of the corresponding devices as described with reference to FIG. 1.

In the following description of the process flow 400, the operations between the UE 115-c, the UE 115-d, and the network entity 105-b may be transmitted in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the UE 115-c may transmit, to the network entity 105-b, a capability message including CLI measurement capability information. For example, the capability information may indicate a capability of the UE 115-c to perform CLI measurements (e.g., CLI-RSSI measurements, CLI-RSRP measurements, or both) via a guard band located between an uplink subband and a downlink subband during a time period allocated for SBFD operation.

At 410, the UE 115-d may transmit, to the network entity 105-b, a capability message including CLI-RS capability information. For example, the capability information may indicate a capability of the UE 115-d to transmit CLI-RSs (e.g., SRSs) in the guard band located between the uplink subband and the downlink subband during the time period allocated for SBFD operation.

At 415, the network entity 105-b may transmit, to the UE 115-c, control signaling indicating one or more resources for measuring CLI (e.g., from the UE 115-d). The one or more resources may overlap (e.g., partially or fully overlap) with the guard band. For example, the one or more resources may fully overlap with the guard band, as described with reference to the CLI measurement scenario 305-a, or may partially overlap with the guard band as described with reference to the CLI measurement scenario 305-b or the CLI measurement scenario 305-c in FIG. 3. In some examples, the one or more resources may overlap (e.g., partially or fully) with the uplink subband and/or the downlink subband, as described with reference to the CLI measurement scenario 305-b and the CLI measurement scenario 305-c in FIG. 3. In some examples, the one or more resources may not overlap with the uplink subband and/or the downlink subband.

In some examples, the control signaling may indicate, to the UE 115-c, one or more SRS resources (e.g., which may include the one or more resources) based at least in part on the capability information (e.g., the CLI-RSRP measurement capability). For example, the one or more SRS resources may correspond to a communication SRS configuration or a positioning SRS configuration. In some examples, the one or more SRS resources may be allocated for one or more CLI measurements (e.g., by the UE 115-c).

At 420, the network entity 105-b may transmit, to the UE 115-d, control signaling indicating one or more resources for transmitting CLI-RSs. The one or more resources may overlap (e.g., partially or fully overlap) with the guard band. For example, the one or more resources may fully overlap with the guard band, as described with reference to the CLI measurement scenario 305-a, or may partially overlap with the guard band as described with reference to the CLI measurement scenario 305-b in FIG. 3. In some examples, the one or more resources may overlap (e.g., partially or fully) with the uplink subband as described with reference to the CLI measurement scenario 305-b in FIG. 3. In some examples, the one or more resources may not overlap with the uplink subband or the downlink subband. In some examples, the control signaling may indicate a threshold transmit power, a transmit beam restriction, or both for the CLI-RSs.

The control signaling may indicate, to the UE 115-d, one or more SRS resources (e.g., which may include the one or more resources). In some examples, the one or more SRS resources may correspond to a communication SRS configuration or a positioning SRS configuration. In some examples, the one or more SRS resources may be allocated for one or more CLI measurements (e.g., by the UE 115-c).

At 425, the UE 115-c may perform one or more CLI measurements via the one or more resources. For example, the UE 115-c may perform one or more CLI-RSSI measurements via the guard band resources. The CLI-RSSI measurements may be measurements of signal leakage from one or more uplink transmissions (e.g., from the UE 115-d).

At 430, the UE 115-d may transmit, to the UE 115-c, the CLI-RSs over the one or more resources based at least in part on receiving the control signaling. For example, the UE 115-d may transmit SRSs over the SRS resources. The UE 115-d may transmit the CLI-RSs according to the threshold transmit power, the transmit beam restriction, or both.

At 435, the UE 115-c may monitor for the one or more CLI-RSs (e.g., the SRSs) from the UE 115-d. The UE 115-c may perform one or more CLI measurements via the one or more resources. For example, the UE 115-c may perform one or more CLI-RSRP measurements of the CLI-RSs via at least the guard band resources.

At 440, the UE 115-c may transmit, to the network entity 105-b, a CLI measurement report. For example, the UE 115-c may transmit a report of the CLI-RSSI measurements, the CLI-RSRP measurements, or both.

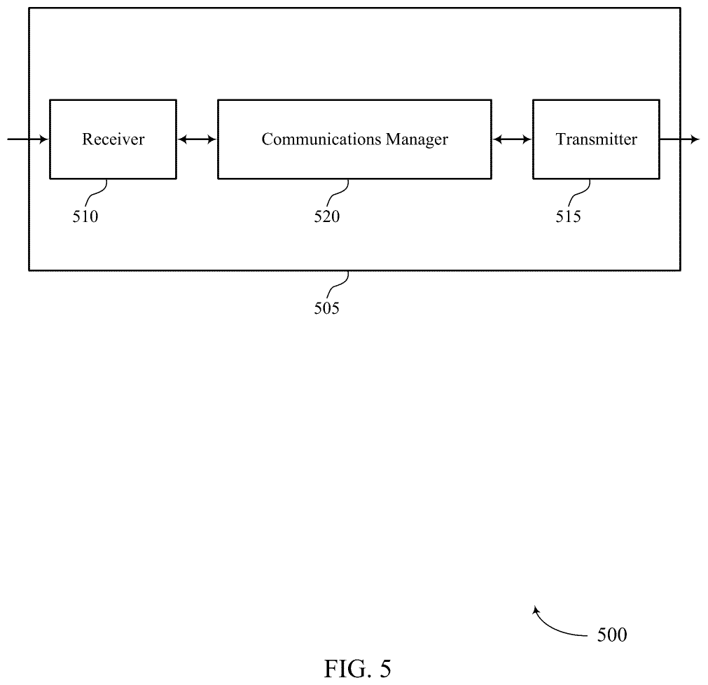

FIG. 5 shows a block diagram 500 of a device 505 that supports CLI reference signal transmission and measurements in SBFD scenarios in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to CLI reference signal transmission and measurements in SBFD scenarios). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to CLI reference signal transmission and measurements in SBFD scenarios). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of CLI reference signal transmission and measurements in SBFD scenarios as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 520, the receiver 510, the transmitter 515, or various combinations or components thereof may be implemented in code (e.g., as communications management software) executed by at least one processor. If implemented in code executed by at least one processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for transmitting capability information indicating that the UE is capable of performing CLI measurements via a guard band located between an uplink subband and a downlink subband during at least one time period allocated for a subband full duplex operation. The communications manager 520 is capable of, configured to, or operable to support a means for receiving, based on transmitting the capability information, control signaling indicating one or more resources for measuring CLI from at least a second UE, the one or more resources at least partially overlapping in frequency with the guard band. The communications manager 520 is capable of, configured to, or operable to support a means for performing one or more CLI measurements via the one or more resources. The communications manager 520 is capable of, configured to, or operable to support a means for transmitting a CLI measurement report based on the one or more CLI measurements.

Additionally, or alternatively, the communications manager 520 may support wireless communications at a UE in accordance with examples as disclosed herein. For example, the communications manager 520 is capable of, configured to, or operable to support a means for transmitting capability information indicating that the UE is capable of transmitting CLI-RSs via a guard band located between an uplink subband and a downlink subband during at least one time period allocated for a subband full duplex operation. The communications manager 520 is capable of, configured to, or operable to support a means for receiving, based on transmitting the capability information, control signaling indicating one or more resources for transmitting the CLI-RSs, the one or more resources at least partially overlapping in frequency with the guard band. The communications manager 520 is capable of, configured to, or operable to support a means for transmitting the CLI-RSs via the one or more resources based on receiving the control signaling indicating the one or more resources.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for guard band CLI measurement and CLI-RS transmissions, which may result in more efficient utilization of communication resources.

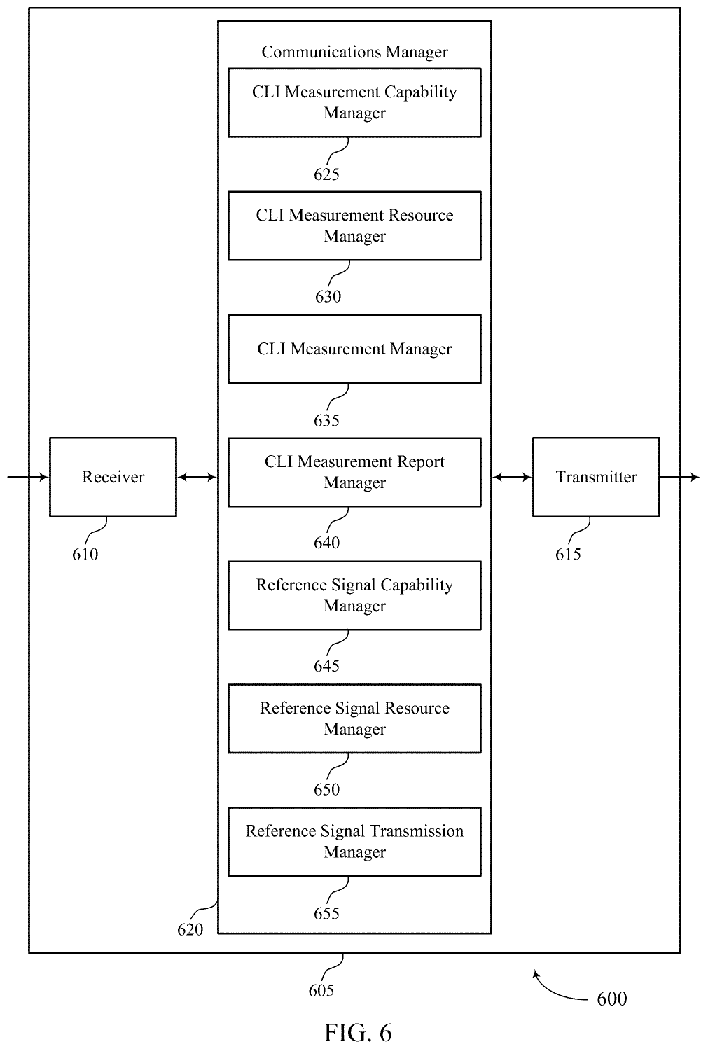

FIG. 6 shows a block diagram 600 of a device 605 that supports CLI reference signal transmission and measurements in SBFD scenarios in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may also include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to CLI reference signal transmission and measurements in SBFD scenarios). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CLI reference signal transmission and measurements in SBFD scenarios). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of CLI reference signal transmission and measurements in SBFD scenarios as described herein. For example, the communications manager 620 may include a CLI measurement capability manager 625, a CLI measurement resource manager 630, a CLI measurement manager 635, a CLI measurement report manager 640, a reference signal capability manager 645, a reference signal resource manager 650, a reference signal transmission manager 655, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The CLI measurement capability manager 625 is capable of, configured to, or operable to support a means for transmitting capability information indicating that the UE is capable of performing CLI measurements via a guard band located between an uplink subband and a downlink subband during at least one time period allocated for a subband full duplex operation. The CLI measurement resource manager 630 is capable of, configured to, or operable to support a means for receiving, based on transmitting the capability information, control signaling indicating one or more resources for measuring CLI from at least a second UE, the one or more resources at least partially overlapping in frequency with the guard band. The CLI measurement manager 635 is capable of, configured to, or operable to support a means for performing one or more CLI measurements via the one or more resources. The CLI measurement report manager 640 is capable of, configured to, or operable to support a means for transmitting a CLI measurement report based on the one or more CLI measurements.

Additionally, or alternatively, the communications manager 620 may support wireless communications at a UE in accordance with examples as disclosed herein. The reference signal capability manager 645 is capable of, configured to, or operable to support a means for transmitting capability information indicating that the UE is capable of transmitting CLI-RSs via a guard band located between an uplink subband and a downlink subband during at least one time period allocated for a subband full duplex operation. The reference signal resource manager 650 is capable of, configured to, or operable to support a means for receiving, based on transmitting the capability information, control signaling indicating one or more resources for transmitting the CLI-RSs, the one or more resources at least partially overlapping in frequency with the guard band. The reference signal transmission manager 655 is capable of, configured to, or operable to support a means for transmitting the CLI-RSs via the one or more resources based on receiving the control signaling indicating the one or more resources.

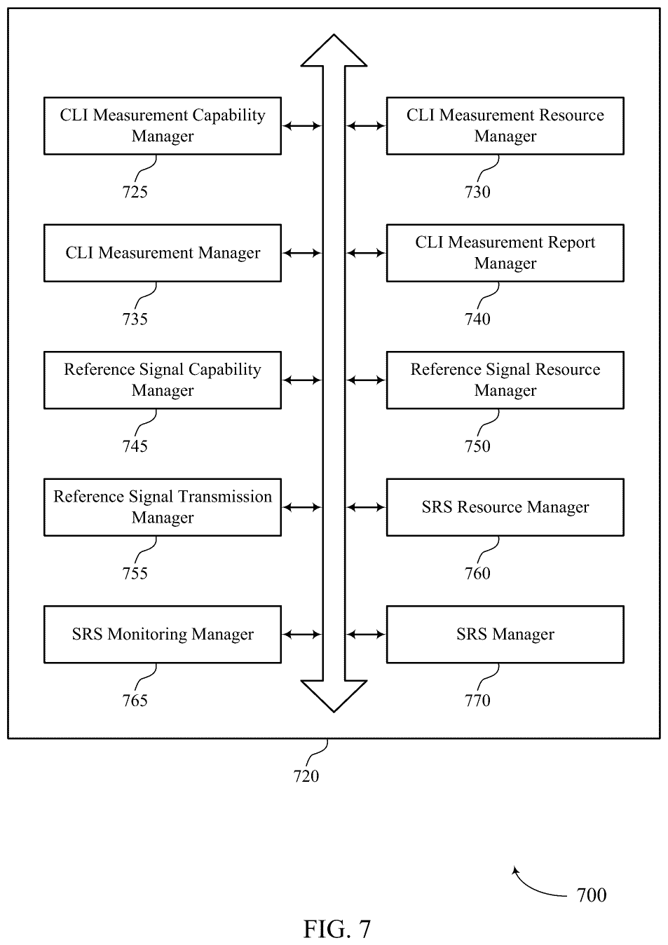

FIG. 7 shows a block diagram 700 of a communications manager 720 that supports CLI reference signal transmission and measurements in SBFD scenarios in accordance with one or more aspects of the present disclosure. The communications manager 720 may be an example of aspects of a communications manager 520, a communications manager 620, or both, as described herein. The communications manager 720, or various components thereof, may be an example of means for performing various aspects of CLI reference signal transmission and measurements in SBFD scenarios as described herein. For example, the communications manager 720 may include a CLI measurement capability manager 725, a CLI measurement resource manager 730, a CLI measurement manager 735, a CLI measurement report manager 740, a reference signal capability manager 745, a reference signal resource manager 750, a reference signal transmission manager 755, an SRS resource manager 760, an SRS monitoring manager 765, an SRS manager 770, or any combination thereof. Each of these components, or components of subcomponents thereof (e.g., one or more processors, one or more memories), may communicate, directly or indirectly, with one another (e.g., via one or more buses).

The communications manager 720 may support wireless communications at a UE in accordance with examples as disclosed herein. The CLI measurement capability manager 725 is capable of, configured to, or operable to support a means for transmitting capability information indicating that the UE is capable of performing CLI measurements via a guard band located between an uplink subband and a downlink subband during at least one time period allocated for a subband full duplex operation. The CLI measurement resource manager 730 is capable of, configured to, or operable to support a means for receiving, based on transmitting the capability information, control signaling indicating one or more resources for measuring CLI from at least a second UE, the one or more resources at least partially overlapping in frequency with the guard band. The CLI measurement manager 735 is capable of, configured to, or operable to support a means for performing one or more CLI measurements via the one or more resources. The CLI measurement report manager 740 is capable of, configured to, or operable to support a means for transmitting a CLI measurement report based on the one or more CLI measurements.

In some examples, the CLI measurement resource manager 730 is capable of, configured to, or operable to support a means for receiving, via the control signaling, an indication that the one or more resources at least partially overlap with the uplink subband, the downlink subband, or both.

In some examples, the CLI measurement resource manager 730 is capable of, configured to, or operable to support a means for receiving, via the control signaling, an indication that the one or more resources do not overlap with the uplink subband or the downlink subband.

In some examples, to support performing the one or more CLI measurements, the CLI measurement manager 735 is capable of, configured to, or operable to support a means for measuring a CLI received signal strength indicator via the one or more resources based on the capability.

In some examples, the SRS resource manager 760 is capable of, configured to, or operable to support a means for receiving, via the control signaling, an indication of a set of multiple SRS resources including the one or more resources based on the capability. In some examples, the SRS monitoring manager 765 is capable of, configured to, or operable to support a means for monitoring for one or more SRSs from at least the second UE via the set of multiple SRS resources. In some examples, the CLI measurement manager 735 is capable of, configured to, or operable to support a means for measuring CLI reference signal receive power via the one or more resources based on the monitoring.

In some examples, the set of multiple SRS resources correspond to a communication SRS configuration, or a positioning SRS configuration, the one or more resources including a subset of the set of multiple SRS resources.

In some examples, the set of multiple SRS resources are allocated for the one or more CLI measurements.

Additionally, or alternatively, the communications manager 720 may support wireless communications at a UE in accordance with examples as disclosed herein. The reference signal capability manager 745 is capable of, configured to, or operable to support a means for transmitting capability information indicating that the UE is capable of transmitting CLI-RSs via a guard band located between an uplink subband and a downlink subband during at least one time period allocated for a subband full duplex operation. The reference signal resource manager 750 is capable of, configured to, or operable to support a means for receiving, based on transmitting the capability information, control signaling indicating one or more resources for transmitting the CLI-RSs, the one or more resources at least partially overlapping in frequency with the guard band. The reference signal transmission manager 755 is capable of, configured to, or operable to support a means for transmitting the CLI-RSs via the one or more resources based on receiving the control signaling indicating the one or more resources.

In some examples, the reference signal transmission manager 755 is capable of, configured to, or operable to support a means for receiving, via the control signaling, an indication of a threshold transmit power, a transmit beam restriction, or both, where transmitting the CLI-RSs includes transmitting the CLI-RSs according to the threshold transmit power, via the transmit beam, or both.

In some examples, the SRS manager 770 is capable of, configured to, or operable to support a means for receiving, via the control signaling, an indication of a set of multiple SRS resources including the one or more resources, where the CLI-RSs include SRSs.

In some examples, the set of multiple SRS resources correspond to a communication SRS configuration, or a positioning SRS configuration, the one or more resources including a subset of the set of multiple SRS resources.

In some examples, the set of multiple SRS resources are allocated for CLI measurements.

In some examples, the reference signal resource manager 750 is capable of, configured to, or operable to support a means for receiving, via the control signaling, an indication that the one or more resources at least partially overlap with the uplink subband.

In some examples, the reference signal resource manager 750 is capable of, configured to, or operable to support a means for receiving, via the control signaling, an indication that the one or more resources do not overlap with the uplink subband or the downlink subband.

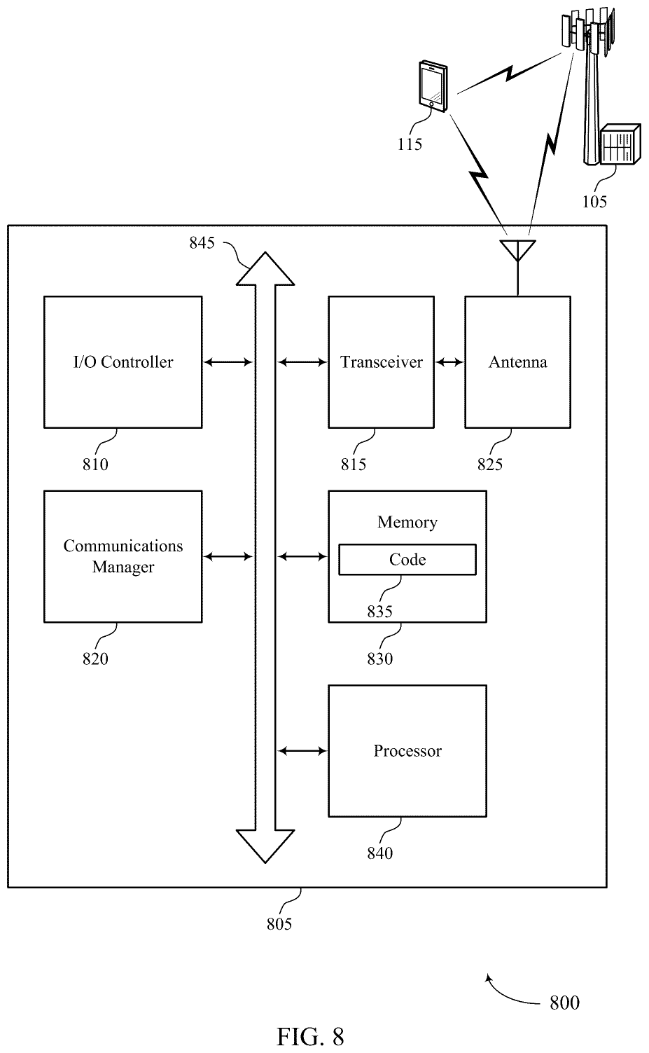

FIG. 8 shows a diagram of a system 800 including a device 805 that supports CLI reference signal transmission and measurements in SBFD scenarios in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting CLI reference signal transmission and measurements in SBFD scenarios). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for transmitting capability information indicating that the UE is capable of performing CLI measurements via a guard band located between an uplink subband and a downlink subband during at least one time period allocated for a subband full duplex operation. The communications manager 820 is capable of, configured to, or operable to support a means for receiving, based on transmitting the capability information, control signaling indicating one or more resources for measuring CLI from at least a second UE, the one or more resources at least partially overlapping in frequency with the guard band. The communications manager 820 is capable of, configured to, or operable to support a means for performing one or more CLI measurements via the one or more resources. The communications manager 820 is capable of, configured to, or operable to support a means for transmitting a CLI measurement report based on the one or more CLI measurements.

Additionally, or alternatively, the communications manager 820 may support wireless communications at a UE in accordance with examples as disclosed herein. For example, the communications manager 820 is capable of, configured to, or operable to support a means for transmitting capability information indicating that the UE is capable of transmitting CLI-RSs via a guard band located between an uplink subband and a downlink subband during at least one time period allocated for a subband full duplex operation. The communications manager 820 is capable of, configured to, or operable to support a means for receiving, based on transmitting the capability information, control signaling indicating one or more resources for transmitting the CLI-RSs, the one or more resources at least partially overlapping in frequency with the guard band. The communications manager 820 is capable of, configured to, or operable to support a means for transmitting the CLI-RSs via the one or more resources based on receiving the control signaling indicating the one or more resources.

By including or configuring the communications manager 820 in accordance with examples as described herein, the device 805 may support techniques for guard band CLI measurement and CLI-RS transmissions, which may result in improved communication reliability and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of CLI reference signal transmission and measurements in SBFD scenarios as described herein, or the processor 840 and the memory 830 may be otherwise configured to perform or support such operations.

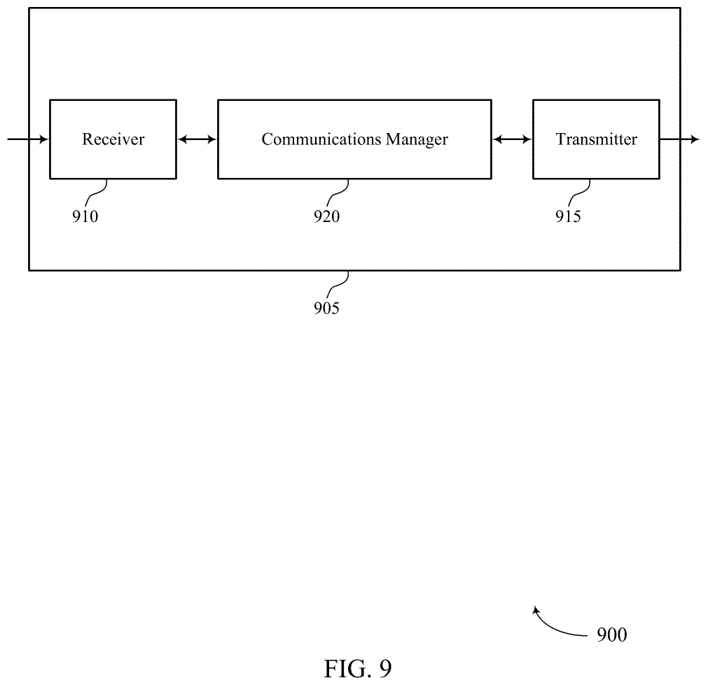

FIG. 9 shows a block diagram 900 of a device 905 that supports CLI reference signal transmission and measurements in SBFD scenarios in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of CLI reference signal transmission and measurements in SBFD scenarios as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, a GPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 920, the receiver 910, the transmitter 915, or various combinations or components thereof may be implemented in code (e.g., as communications management software) executed by at least one processor. If implemented in code executed by at least one processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for receiving, from a set of multiple user equipment (UEs), capability information indicating a capability to support CLI measurements via a guard band located between an uplink subband and a downlink subband during at least one time period allocated for a subband full duplex operation. The communications manager 920 is capable of, configured to, or operable to support a means for transmitting, based on receiving the capability information, control signaling indicating one or more resources for CLI measurement, the one or more resources at least partially overlapping in frequency with the guard band. The communications manager 920 is capable of, configured to, or operable to support a means for receiving, from at least a first UE of the set of multiple UEs, a CLI measurement report.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for guard band CLI measurement and CLI-RS transmissions, which may result in more efficient utilization of communication resources.

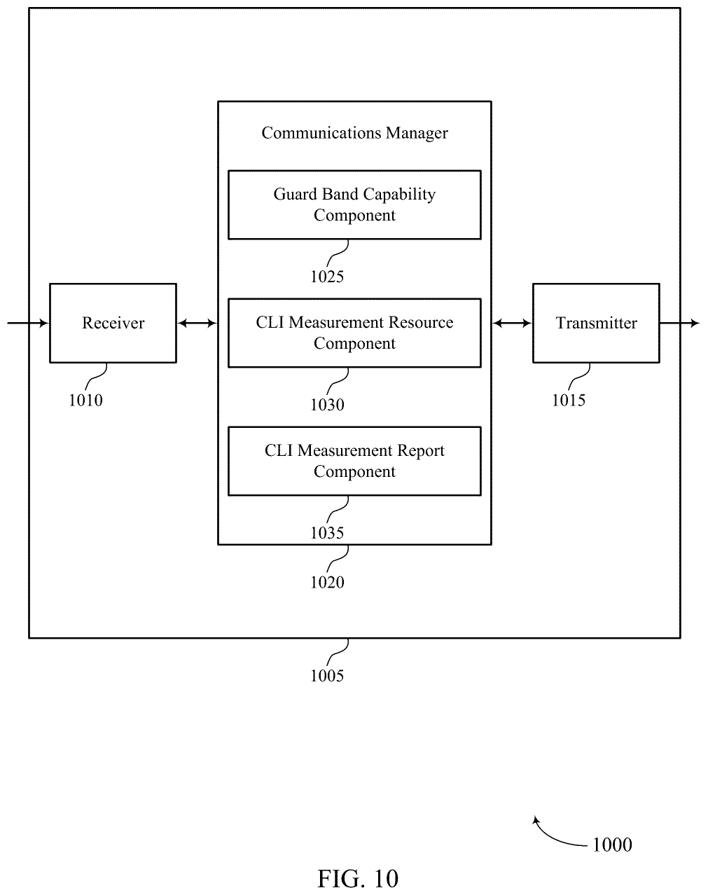

FIG. 10 shows a block diagram 1000 of a device 1005 that supports CLI reference signal transmission and measurements in SBFD scenarios in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may also include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of CLI reference signal transmission and measurements in SBFD scenarios as described herein. For example, the communications manager 1020 may include a guard band capability component 1025, a CLI measurement resource component 1030, a CLI measurement report component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The guard band capability component 1025 is capable of, configured to, or operable to support a means for receiving, from a set of multiple user equipment (UEs), capability information indicating a capability to support CLI measurements via a guard band located between an uplink subband and a downlink subband during at least one time period allocated for a subband full duplex operation. The CLI measurement resource component 1030 is capable of, configured to, or operable to support a means for transmitting, based on receiving the capability information, control signaling indicating one or more resources for CLI measurement, the one or more resources at least partially overlapping in frequency with the guard band. The CLI measurement report component 1035 is capable of, configured to, or operable to support a means for receiving, from at least a first UE of the set of multiple UEs, a CLI measurement report.

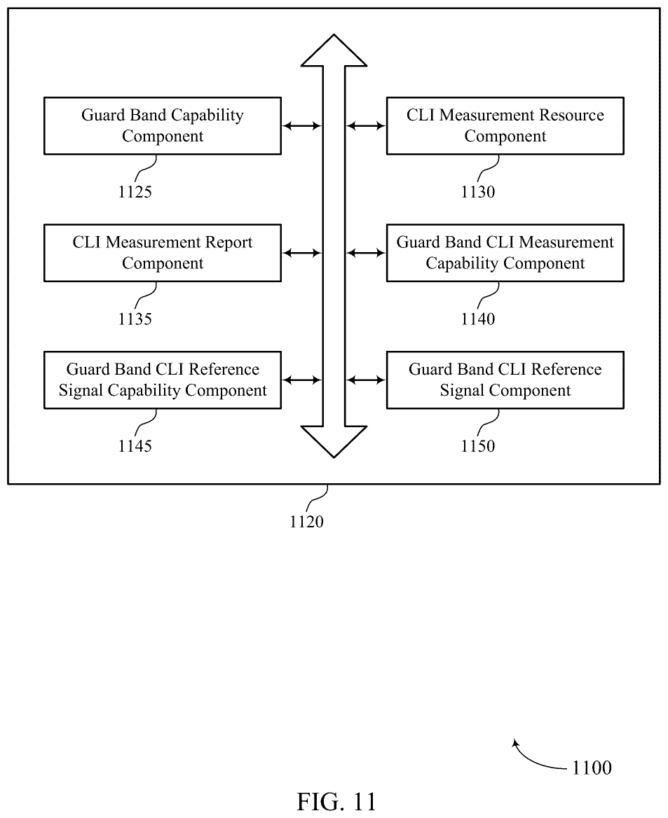

FIG. 11 shows a block diagram 1100 of a communications manager 1120 that supports CLI reference signal transmission and measurements in SBFD scenarios in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of CLI reference signal transmission and measurements in SBFD scenarios as described herein. For example, the communications manager 1120 may include a guard band capability component 1125, a CLI measurement resource component 1130, a CLI measurement report component 1135, a guard band CLI measurement capability component 1140, a guard band CLI reference signal capability component 1145, a guard band CLI reference signal component 1150, or any combination thereof. Each of these components, or components of subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The guard band capability component 1125 is capable of, configured to, or operable to support a means for receiving, from a set of multiple user equipment (UEs), capability information indicating a capability to support CLI measurements via a guard band located between an uplink subband and a downlink subband during at least one time period allocated for a subband full duplex operation. The CLI measurement resource component 1130 is capable of, configured to, or operable to support a means for transmitting, based on receiving the capability information, control signaling indicating one or more resources for CLI measurement, the one or more resources at least partially overlapping in frequency with the guard band. The CLI measurement report component 1135 is capable of, configured to, or operable to support a means for receiving, from at least a first UE of the set of multiple UEs, a CLI measurement report.

In some examples, to support receiving the capability information, the guard band CLI measurement capability component 1140 is capable of, configured to, or operable to support a means for receiving the capability information from the first UE, the capability information including an indication that the first UE is capable of performing CLI measurements via the guard band.

In some examples, to support receiving the capability information, the guard band CLI reference signal capability component 1145 is capable of, configured to, or operable to support a means for receiving the capability information from a second UE, the capability information including an indication that the second UE is capable of transmitting CLI-RSs via the guard band.

In some examples, the guard band CLI reference signal component 1150 is capable of, configured to, or operable to support a means for transmitting, to the second UE via the control signaling based on the capability information, an indication of a threshold transmit power, a transmit beam restriction, or both.

In some examples, the CLI measurement resource component 1130 is capable of, configured to, or operable to support a means for transmitting, via the control signaling, an indication of a set of multiple SRS resources including the one or more resources.

In some examples, the set of multiple SRS resources correspond to a communication SRS configuration, or a positioning SRS configuration, the one or more resources including a subset of the set of multiple SRS resources.

In some examples, the set of multiple SRS resources are allocated for CLI measurements.

In some examples, the CLI measurement resource component 1130 is capable of, configured to, or operable to support a means for transmitting, via the control signaling, an indication that the one or more resources at least partially overlap with the uplink subband.

In some examples, the CLI measurement resource component 1130 is capable of, configured to, or operable to support a means for transmitting, via the control signaling, an indication that the one or more resources do not overlap with the uplink subband or the downlink subband.

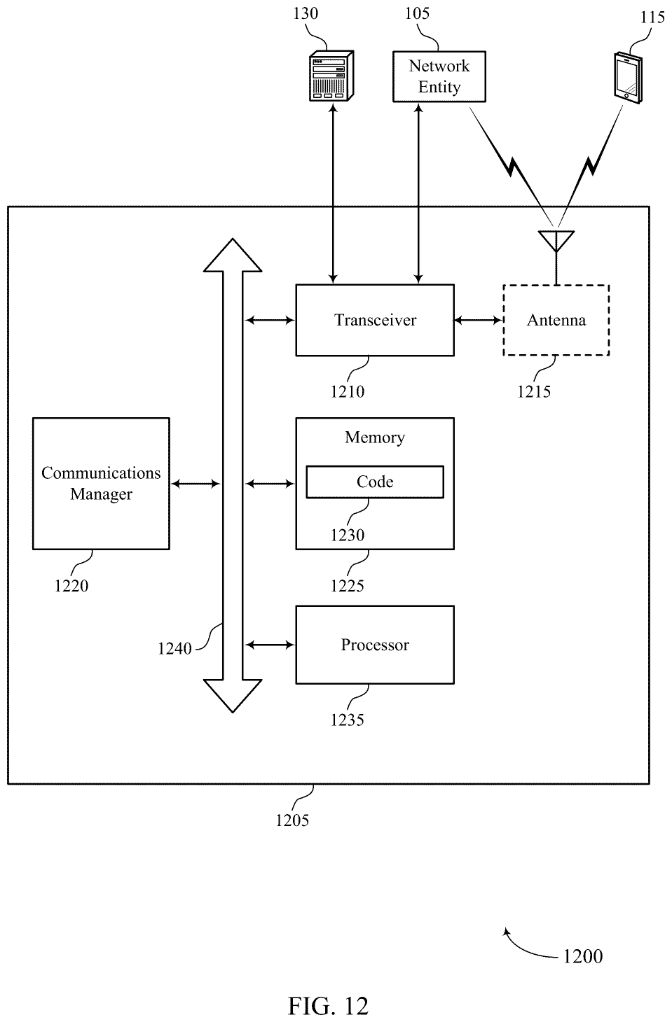

FIG. 12 shows a diagram of a system 1200 including a device 1205 that supports CLI reference signal transmission and measurements in SBFD scenarios in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting CLI reference signal transmission and measurements in SBFD scenarios). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for receiving, from a set of multiple user equipment (UEs), capability information indicating a capability to support CLI measurements via a guard band located between an uplink subband and a downlink subband during at least one time period allocated for a subband full duplex operation. The communications manager 1220 is capable of, configured to, or operable to support a means for transmitting, based on receiving the capability information, control signaling indicating one or more resources for CLI measurement, the one or more resources at least partially overlapping in frequency with the guard band. The communications manager 1220 is capable of, configured to, or operable to support a means for receiving, from at least a first UE of the set of multiple UEs, a CLI measurement report.

By including or configuring the communications manager 1220 in accordance with examples as described herein, the device 1205 may support techniques for guard band CLI measurement and CLI-RS transmissions, which may result in improved communication reliability and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of CLI reference signal transmission and measurements in SBFD scenarios as described herein, or the processor 1235 and the memory 1225 may be otherwise configured to perform or support such operations.

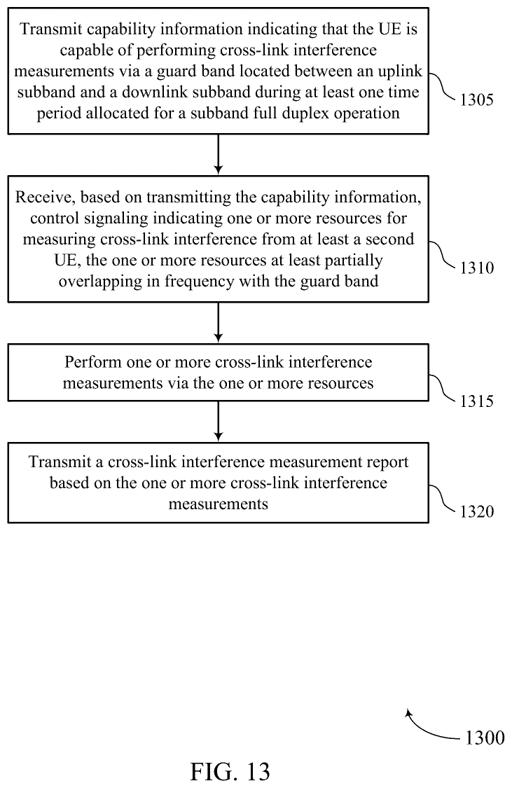

FIG. 13 shows a flowchart illustrating a method 1300 that supports CLI reference signal transmission and measurements in SBFD scenarios in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting capability information indicating that the UE is capable of performing CLI measurements via a guard band located between an uplink subband and a downlink subband during at least one time period allocated for a subband full duplex operation. The operations of block 1305 may be performed in accordance with examples as disclosed herein. In some examples, aspects of the operations of 1305 may be performed by a CLI measurement capability manager 725 as described with reference to FIG. 7.

At 1310, the method may include receiving, based on transmitting the capability information, control signaling indicating one or more resources for measuring CLI from at least a second UE, the one or more resources at least partially overlapping in frequency with the guard band. The operations of block 1310 may be performed in accordance with examples as disclosed herein. In some examples, aspects of the operations of 1310 may be performed by a CLI measurement resource manager 730 as described with reference to FIG. 7.

At 1315, the method may include performing one or more CLI measurements via the one or more resources. The operations of block 1315 may be performed in accordance with examples as disclosed herein. In some examples, aspects of the operations of 1315 may be performed by a CLI measurement manager 735 as described with reference to FIG. 7.

At 1320, the method may include transmitting a CLI measurement report based on the one or more CLI measurements. The operations of block 1320 may be performed in accordance with examples as disclosed herein. In some examples, aspects of the operations of 1320 may be performed by a CLI measurement report manager 740 as described with reference to FIG. 7.

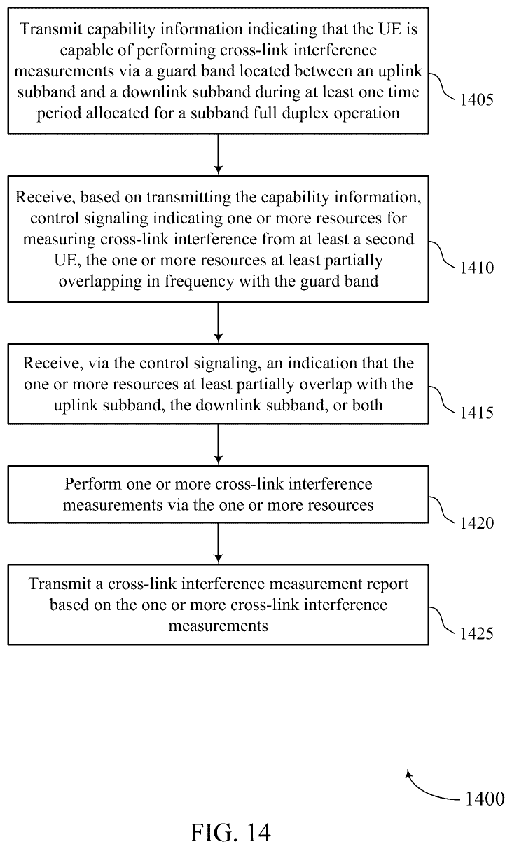

FIG. 14 shows a flowchart illustrating a method 1400 that supports CLI reference signal transmission and measurements in SBFD scenarios in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting capability information indicating that the UE is capable of performing CLI measurements via a guard band located between an uplink subband and a downlink subband during at least one time period allocated for a subband full duplex operation. The operations of block 1405 may be performed in accordance with examples as disclosed herein. In some examples, aspects of the operations of 1405 may be performed by a CLI measurement capability manager 725 as described with reference to FIG. 7.

At 1410, the method may include receiving, based on transmitting the capability information, control signaling indicating one or more resources for measuring CLI from at least a second UE, the one or more resources at least partially overlapping in frequency with the guard band. The operations of block 1410 may be performed in accordance with examples as disclosed herein. In some examples, aspects of the operations of 1410 may be performed by a CLI measurement resource manager 730 as described with reference to FIG. 7.

At 1415, the method may include receiving, via the control signaling, an indication that the one or more resources at least partially overlap with the uplink subband, the downlink subband, or both. The operations of block 1415 may be performed in accordance with examples as disclosed herein. In some examples, aspects of the operations of 1415 may be performed by a CLI measurement resource manager 730 as described with reference to FIG. 7.

At 1420, the method may include performing one or more CLI measurements via the one or more resources. The operations of block 1420 may be performed in accordance with examples as disclosed herein. In some examples, aspects of the operations of 1420 may be performed by a CLI measurement manager 735 as described with reference to FIG. 7.

At 1425, the method may include transmitting a CLI measurement report based on the one or more CLI measurements. The operations of block 1425 may be performed in accordance with examples as disclosed herein. In some examples, aspects of the operations of 1425 may be performed by a CLI measurement report manager 740 as described with reference to FIG. 7.

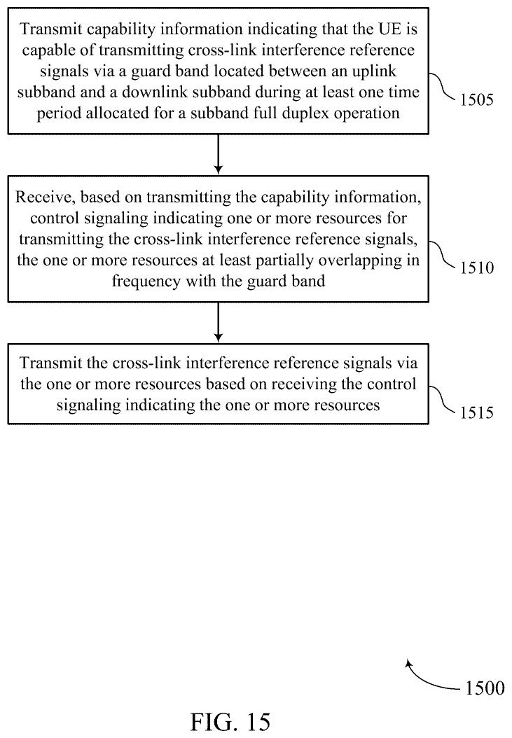

FIG. 15 shows a flowchart illustrating a method 1500 that supports CLI reference signal transmission and measurements in SBFD scenarios in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting capability information indicating that the UE is capable of transmitting CLI-RSs via a guard band located between an uplink subband and a downlink subband during at least one time period allocated for a subband full duplex operation. The operations of block 1505 may be performed in accordance with examples as disclosed herein. In some examples, aspects of the operations of 1505 may be performed by a reference signal capability manager 745 as described with reference to FIG. 7.

At 1510, the method may include receiving, based on transmitting the capability information, control signaling indicating one or more resources for transmitting the CLI-RSs, the one or more resources at least partially overlapping in frequency with the guard band. The operations of block 1510 may be performed in accordance with examples as disclosed herein. In some examples, aspects of the operations of 1510 may be performed by a reference signal resource manager 750 as described with reference to FIG. 7.

At 1515, the method may include transmitting the CLI-RSs via the one or more resources based on receiving the control signaling indicating the one or more resources. The operations of block 1515 may be performed in accordance with examples as disclosed herein. In some examples, aspects of the operations of 1515 may be performed by a reference signal transmission manager 755 as described with reference to FIG. 7.

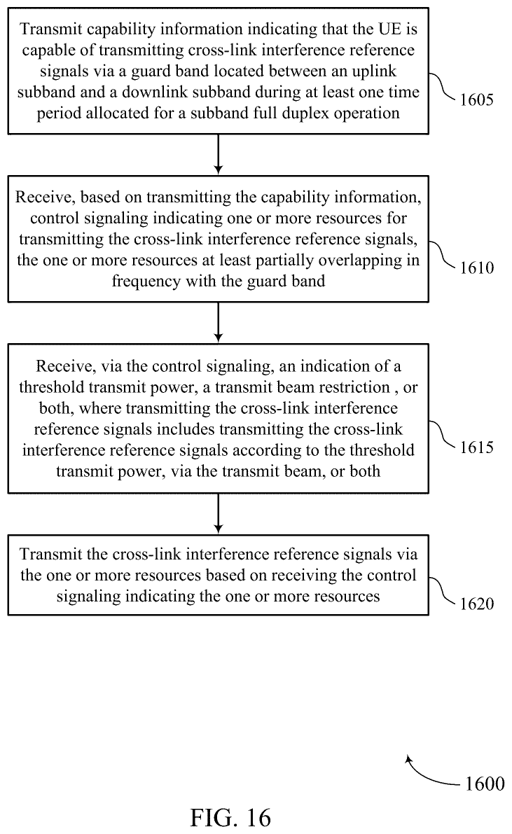

FIG. 16 shows a flowchart illustrating a method 1600 that supports CLI reference signal transmission and measurements in SBFD scenarios in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include transmitting capability information indicating that the UE is capable of transmitting CLI-RSs via a guard band located between an uplink subband and a downlink subband during at least one time period allocated for a subband full duplex operation. The operations of block 1605 may be performed in accordance with examples as disclosed herein. In some examples, aspects of the operations of 1605 may be performed by a reference signal capability manager 745 as described with reference to FIG. 7.

At 1610, the method may include receiving, based on transmitting the capability information, control signaling indicating one or more resources for transmitting the CLI-RSs, the one or more resources at least partially overlapping in frequency with the guard band. The operations of block 1610 may be performed in accordance with examples as disclosed herein. In some examples, aspects of the operations of 1610 may be performed by a reference signal resource manager 750 as described with reference to FIG. 7.

At 1615, the method may include receiving, via the control signaling, an indication of a threshold transmit power, a transmit beam restriction, or both, where transmitting the CLI-RSs includes transmitting the CLI-RSs according to the threshold transmit power, via the transmit beam, or both. The operations of block 1615 may be performed in accordance with examples as disclosed herein. In some examples, aspects of the operations of 1615 may be performed by a reference signal transmission manager 755 as described with reference to FIG. 7.

At 1620, the method may include transmitting the CLI-RSs via the one or more resources based on receiving the control signaling indicating the one or more resources. The operations of block 1620 may be performed in accordance with examples as disclosed herein. In some examples, aspects of the operations of 1620 may be performed by a reference signal transmission manager 755 as described with reference to FIG. 7.

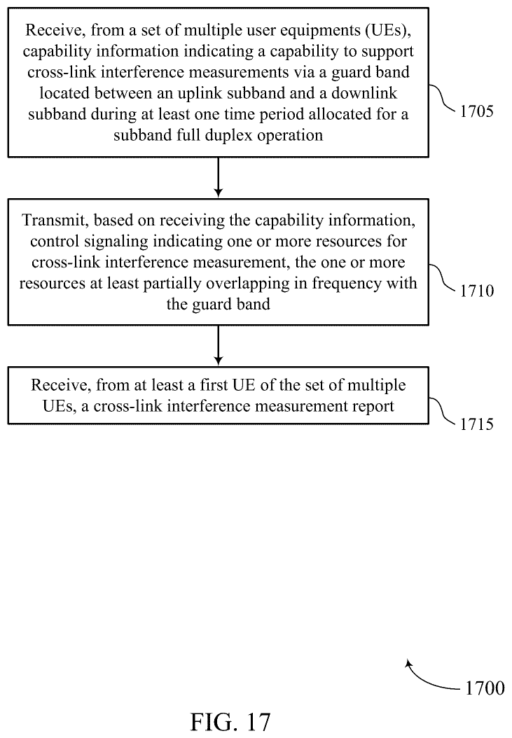

FIG. 17 shows a flowchart illustrating a method 1700 that supports CLI reference signal transmission and measurements in SBFD scenarios in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include receiving, from a set of multiple user equipment (UEs), capability information indicating a capability to support CLI measurements via a guard band located between an uplink subband and a downlink subband during at least one time period allocated for a subband full duplex operation. The operations of block 1705 may be performed in accordance with examples as disclosed herein. In some examples, aspects of the operations of 1705 may be performed by a guard band capability component 1125 as described with reference to FIG. 11.

At 1710, the method may include transmitting, based on receiving the capability information, control signaling indicating one or more resources for CLI measurement, the one or more resources at least partially overlapping in frequency with the guard band. The operations of block 1710 may be performed in accordance with examples as disclosed herein. In some examples, aspects of the operations of 1710 may be performed by a CLI measurement resource component 1130 as described with reference to FIG. 11.

At 1715, the method may include receiving, from at least a first UE of the set of multiple UEs, a CLI measurement report. The operations of block 1715 may be performed in accordance with examples as disclosed herein. In some examples, aspects of the operations of 1715 may be performed by a CLI measurement report component 1135 as described with reference to FIG. 11.

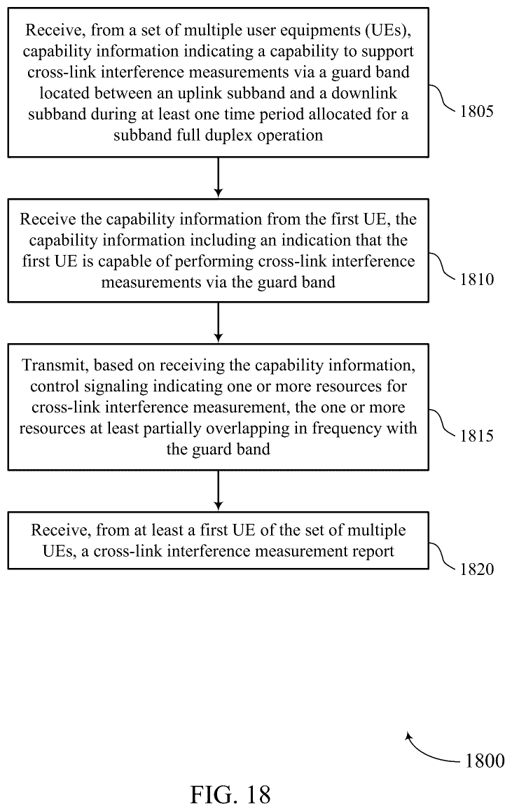

FIG. 18 shows a flowchart illustrating a method 1800 that supports CLI

reference signal transmission and measurements in SBFD scenarios in accordance with aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include receiving, from a set of multiple user equipment (UEs), capability information indicating a capability to support CLI measurements via a guard band located between an uplink subband and a downlink subband during at least one time period allocated for a subband full duplex operation. The operations of block 1805 may be performed in accordance with examples as disclosed herein. In some examples, aspects of the operations of 1805 may be performed by a guard band capability component 1125 as described with reference to FIG. 11.

At 1810, the method may include receiving the capability information from the first UE, the capability information including an indication that the first UE is capable of performing CLI measurements via the guard band. The operations of block 1810 may be performed in accordance with examples as disclosed herein. In some examples, aspects of the operations of 1810 may be performed by a guard band CLI measurement capability component 1140 as described with reference to FIG. 11.

At 1815, the method may include transmitting, based on receiving the capability information, control signaling indicating one or more resources for CLI measurement, the one or more resources at least partially overlapping in frequency with the guard band. The operations of block 1815 may be performed in accordance with examples as disclosed herein. In some examples, aspects of the operations of 1815 may be performed by a CLI measurement resource component 1130 as described with reference to FIG. 11.

At 1820, the method may include receiving, from at least a first UE of the set of multiple UEs, a CLI measurement report. The operations of block 1820 may be performed in accordance with examples as disclosed herein. In some examples, aspects of the operations of 1820 may be performed by a CLI measurement report component 1135 as described with reference to FIG. 11.

The following provides an overview of aspects of the present disclosure:

Aspect 1: A method for wireless communications at a UE, comprising: transmitting capability information indicating that the UE is capable of performing CLI measurements via a guard band located between an uplink subband and a downlink subband during at least one time period allocated for a subband full duplex operation; receiving, based at least in part on transmitting the capability information, control signaling indicating one or more resources for measuring CLI from at least a second UE, the one or more resources at least partially overlapping in frequency with the guard band; performing one or more CLI measurements via the one or more resources; and transmitting a CLI measurement report based at least in part on the one or more CLI measurements.

Aspect 2: The method of aspect 1, further comprising: receiving, via the control signaling, an indication that the one or more resources at least partially overlap with the uplink subband, the downlink subband, or both.

Aspect 3: The method of aspect 1, further comprising: receiving, via the control signaling, an indication that the one or more resources do not overlap with the uplink subband or the downlink subband.

Aspect 4: The method of any of aspects 1 through 3, wherein performing the one or more CLI measurements comprises: measuring a CLI-RSSI via the one or more resources based on the capability.

Aspect 5: The method of any of aspects 1 through 4, further comprising: receiving, via the control signaling, an indication of a plurality of SRS resources comprising the one or more resources based on the capability; monitoring for one or more SRSs from at least the second UE via the plurality of SRS resources; and measuring CLI-RSRP via the one or more resources based at least in part on the monitoring.

Aspect 6: The method of aspect 5, wherein the plurality of SRS resources correspond to a communication SRS configuration, or a positioning SRS configuration, the one or more resources comprising a subset of the plurality of SRS resources.

Aspect 7: The method of any of aspects 5 through 6, wherein the plurality of SRS resources are allocated for the one or more CLI measurements.

Aspect 8: A method for wireless communications at a UE, comprising: transmitting capability information indicating that the UE is capable of transmitting CLI-RSs via a guard band located between an uplink subband and a downlink subband during at least one time period allocated for a subband full duplex operation; receiving, based at least in part on transmitting the capability information, control signaling indicating one or more resources for transmitting the CLI-RSs, the one or more resources at least partially overlapping in frequency with the guard band; and transmitting the CLI-RSs via the one or more resources based at least in part on receiving the control signaling indicating the one or more resources.

Aspect 9: The method of aspect 8, further comprising: receiving, via the control signaling, an indication of a threshold transmit power, a transmit beam restriction, or both, wherein transmitting the CLI-RSs comprises transmitting the CLI-RSs according to the threshold transmit power, via the transmit beam, or both.

Aspect 10: The method of any of aspects 8 through 9, further comprising: receiving, via the control signaling, an indication of a plurality of SRS resources comprising the one or more resources, wherein the CLI-RSs comprise SRSs.

Aspect 11: The method of aspect 10, wherein the plurality of SRS resources correspond to a communication SRS configuration, or a positioning SRS configuration, the one or more resources comprising a subset of the plurality of SRS resources.

Aspect 12: The method of any of aspects 10 through 11, wherein the plurality of SRS resources are allocated for CLI measurements.

Aspect 13: The method of any of aspects 8 through 12, further comprising: receiving, via the control signaling, an indication that the one or more resources at least partially overlap with the uplink subband.

Aspect 14: The method of any of aspects 8 through 12, further comprising: receiving, via the control signaling, an indication that the one or more resources do not overlap with the uplink subband or the downlink subband.

Aspect 15: A method for wireless communications at a network entity, comprising: receiving, from a plurality of user equipment (UEs), capability information indicating a capability to support CLI measurements via a guard band located between an uplink subband and a downlink subband during at least one time period allocated for a subband full duplex operation; transmitting, based at least in part on receiving the capability information, control signaling indicating one or more resources for CLI measurement, the one or more resources at least partially overlapping in frequency with the guard band; and receiving, from at least a first UE of the plurality of UEs, a CLI measurement report.

Aspect 16: The method of aspect 15, wherein receiving the capability information comprises: receiving the capability information from the first UE, the capability information comprising an indication that the first UE is capable of performing CLI measurements via the guard band.

Aspect 17: The method of any of aspects 15 through 16, wherein receiving the capability information comprises: receiving the capability information from a second UE, the capability information comprising an indication that the second UE is capable of transmitting CLI-RSs via the guard band.

Aspect 18: The method of aspect 17, further comprising: transmitting, to the second UE via the control signaling based at least in part on the capability information, an indication of a threshold transmit power, a transmit beam restriction, or both.

Aspect 19: The method of any of aspects 15 through 18, further comprising: transmitting, via the control signaling, an indication of a plurality of SRS resources comprising the one or more resources.

Aspect 20: The method of aspect 19, wherein the plurality of SRS resources correspond to a communication SRS configuration, or a positioning SRS configuration, the one or more resources comprising a subset of the plurality of SRS resources.

Aspect 21: The method of any of aspects 19 through 20, wherein the plurality of SRS resources are allocated for CLI measurements.

Aspect 22: The method of any of aspects 15 through 21, further comprising: transmitting, via the control signaling, an indication that the one or more resources at least partially overlap with the uplink subband.

Aspect 23: The method of any of aspects 15 through 21, further comprising: transmitting, via the control signaling, an indication that the one or more resources do not overlap with the uplink subband or the downlink subband.

Aspect 24: An apparatus for wireless communications at a UE, comprising at least one processor; at least one memory coupled (e.g., operatively, communicatively, functionally, electronically, or electrically) with the at least one processor; and instructions stored in the at least one memory and executable by the at least one processor (e.g., directly, indirectly, after pre-processing, without pre-processing) to cause the apparatus to perform a method of any of aspects 1 through 7.

Aspect 25: An apparatus for wireless communications at a UE, comprising at least one means for performing a method of any of aspects 1 through 7.

Aspect 26: A non-transitory computer-readable medium storing code for wireless communications at a UE, the code comprising instructions executable by at least one processor (e.g., directly, indirectly, after pre-processing, without pre-processing) to perform a method of any of aspects 1 through 7.

Aspect 27: An apparatus for wireless communications at a UE, comprising at least one processor; at least one memory coupled (e.g., operatively, communicatively, functionally, electronically, or electrically) with the at least one processor; and instructions stored in the at least one memory and executable by the at least one processor (e.g., directly, indirectly, after pre-processing, without pre-processing) to cause the apparatus to perform a method of any of aspects 8 through 14.

Aspect 28: An apparatus for wireless communications at a UE, comprising at least one means for performing a method of any of aspects 8 through 14.

Aspect 29: A non-transitory computer-readable medium storing code for wireless communications at a UE, the code comprising instructions executable by at least one processor (e.g., directly, indirectly, after pre-processing, without pre-processing) to perform a method of any of aspects 8 through 14.

Aspect 30: An apparatus for wireless communications at a network entity, comprising at least one processor; at least one memory coupled (e.g., operatively, communicatively, functionally, electronically, or electrically) with the at least one processor; and instructions stored in the at least one memory and executable by the at least one processor (e.g., directly, indirectly, after pre-processing, without pre-processing) to cause the apparatus to perform a method of any of aspects 15 through 23.

Aspect 31: An apparatus for wireless communications at a network entity, comprising at least one means for performing a method of any of aspects 15 through 23.

Aspect 32: A non-transitory computer-readable medium storing code for wireless communications at a network entity, the code comprising instructions executable by at least one processor (e.g., directly, indirectly, after pre-processing, without pre-processing) to perform a method of any of aspects 15 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
at least one memory coupled with the at least one processor, the at least one memory storing instructions executable by the at least one processor to cause the UE to:
transmit capability information indicating that the UE is capable of performing cross-link interference measurements via a guard band located between an uplink subband and a downlink subband during at least one time period allocated for a subband full duplex operation;
receive, based at least in part on transmitting the capability information, control signaling indicating one or more resources for measuring cross-link interference from at least a second UE, the one or more resources at least partially overlapping in frequency with the guard band;
perform one or more cross-link interference measurements via the one or more resources; and
transmit a cross-link interference measurement report based at least in part on the one or more cross-link interference measurements.

2. The apparatus of claim 1, wherein the instructions are further executable by the at least one processor to cause the UE to:
receive, via the control signaling, an indication that the one or more resources at least partially overlap with the uplink subband, the downlink subband, or both.

3. The apparatus of claim 1, wherein the instructions are further executable by the at least one processor to cause the UE to:
receive, via the control signaling, an indication that the one or more resources do not overlap with the uplink subband or the downlink subband.

4. The apparatus of claim 1, wherein the instructions to perform the one or more cross-link interference measurements are executable by the at least one processor to cause the UE to:
measure a cross-link interference received signal strength indicator via the one or more resources based on the capability.

5. The apparatus of claim 1, wherein the instructions are further executable by the at least one processor to cause the UE to:
receive, via the control signaling, an indication of a plurality of SRS resources comprising the one or more resources based on the capability;
monitor for one or more SRSs from at least the second UE via the plurality of SRS resources; and
measure cross-link interference reference signal receive power via the one or more resources based at least in part on the monitoring.

6. The apparatus of claim 5, wherein the plurality of SRS resources correspond to a communication SRS configuration or a positioning SRS configuration, the one or more resources comprising a subset of the plurality of SRS resources.

7. The apparatus of claim 5, wherein the plurality of SRS resources are allocated for the one or more cross-link interference measurements.

8. An apparatus for wireless communications at a user equipment (UE), comprising:
at least one processor; and
at least one memory coupled with the at least one processor, the at least one memory storing instructions executable by the at least one processor to cause the UE to:
transmit capability information indicating that the UE is capable of transmitting cross-link interference reference signals via a guard band located between an uplink subband and a downlink subband during at least one time period allocated for a subband full duplex operation;
receive, based at least in part on transmitting the capability information, control signaling indicating one or more resources for transmitting the cross-link interference reference signals, the one or more resources at least partially overlapping in frequency with the guard band; and
transmit the cross-link interference reference signals via the one or more resources based at least in part on receiving the control signaling indicating the one or more resources.

9. The apparatus of claim 8, wherein the instructions are further executable by the at least one processor to cause the UE to:
receive, via the control signaling, an indication of a threshold transmit power, a transmit beam restriction, or both, wherein transmitting the cross-link interference reference signals comprises transmitting the cross-link interference reference signals according to the threshold transmit power, via the transmit beam, or both.

10. The apparatus of claim 8, wherein the instructions are further executable by the at least one processor to cause the UE to:
receive, via the control signaling, an indication of a plurality of sounding reference signal resources comprising the one or more resources, wherein the cross-link interference reference signals comprise sounding reference signals.

11. The apparatus of claim 10, wherein the plurality of sounding reference signal resources correspond to a communication sounding reference signal configuration or a positioning sounding reference signal configuration, the one or more resources comprising a subset of the plurality of sounding reference signal resources.

12. The apparatus of claim 10, wherein the plurality of sounding reference signal resources are allocated for cross-link interference measurements.

13. The apparatus of claim 8, wherein the instructions are further executable by the at least one processor to cause the UE to:
receive, via the control signaling, an indication that the one or more resources at least partially overlap with the uplink subband.

14. The apparatus of claim 8, wherein the instructions are further executable by the at least one processor to cause the UE to:
receive, via the control signaling, an indication that the one or more resources do not overlap with the uplink subband or the downlink subband.

15. An apparatus for wireless communications at a network entity, comprising:
at least one processor; and
at least one memory coupled with the at least one processor, the at least one memory storing instructions executable by the at least one processor to cause the network entity to:
receive, from a plurality of user equipment (UEs), capability information indicating a capability to support cross-link interference measurements via a guard band located between an uplink subband and a downlink subband during at least one time period allocated for a subband full duplex operation;
transmit, based at least in part on receiving the capability information, control signaling indicating one or more resources for cross-link interference measurement, the one or more resources at least partially overlapping in frequency with the guard band; and
receive, from at least a first UE of the plurality of UEs, a cross-link interference measurement report.

16. The apparatus of claim 15, wherein the instructions to receive the capability information are executable by the at least one processor to cause the network entity to:
receive the capability information from the first UE, the capability information comprising an indication that the first UE is capable of performing cross-link interference measurements via the guard band.

17. The apparatus of claim 15, wherein the instructions to receive the capability information are executable by the at least one processor to cause the network entity to:
receive the capability information from a second UE, the capability information comprising an indication that the second UE is capable of transmitting cross-link interference reference signals via the guard band.

18. The apparatus of claim 17, wherein the instructions are further executable by the at least one processor to cause the network entity to:
transmit, to the second UE via the control signaling based at least in part on the capability information, an indication of a threshold transmit power, a transmit beam restriction, or both.

19. The apparatus of claim 15, wherein the instructions are further executable by the at least one processor to cause the network entity to:
transmit, via the control signaling, an indication of a plurality of sounding reference signal resources comprising the one or more resources.

20. The apparatus of claim 19, wherein the plurality of sounding reference signal resources correspond to a communication sounding reference signal configuration or a positioning sounding reference signal configuration, the one or more resources comprising a subset of the plurality of sounding reference signal resources.

21. The apparatus of claim 19, wherein the plurality of sounding reference signal resources are allocated for cross-link interference measurements.

22. The apparatus of claim 15, wherein the instructions are further executable by the at least one processor to cause the network entity to:
transmit, via the control signaling, an indication that the one or more resources at least partially overlap with the uplink subband.

23. The apparatus of claim 15, wherein the instructions are further executable by the at least one processor to cause the network entity to:
transmit, via the control signaling, an indication that the one or more resources do not overlap with the uplink subband or the downlink subband.

24. A method for wireless communications at a user equipment (UE), comprising:
transmitting capability information indicating that the UE is capable of performing cross-link interference measurements via a guard band located between an uplink subband and a downlink subband during at least one time period allocated for a subband full duplex operation;
receiving, based at least in part on transmitting the capability information, control signaling indicating one or more resources for measuring cross-link interference from at least a second UE, the one or more resources at least partially overlapping in frequency with the guard band;
performing one or more cross-link interference measurements via the one or more resources; and
transmitting a cross-link interference measurement report based at least in part on the one or more cross-link interference measurements.

25. The method of claim 24, further comprising:
receiving, via the control signaling, an indication that the one or more resources at least partially overlap with the uplink subband, the downlink subband, or both.

26. The method of claim 24, further comprising:
receiving, via the control signaling, an indication that the one or more resources do not overlap with the uplink subband or the downlink subband.

27. The method of claim 24, wherein performing the one or more cross-link interference measurements comprises:
measuring a cross-link interference received signal strength indicator via the one or more resources based on the capability.

28. The method of claim 24, further comprising:
receiving, via the control signaling, an indication of a plurality of sounding reference signal resources comprising the one or more resources based on the capability;
monitoring for one or more sounding reference signals from at least the second UE via the plurality of sounding reference signal resources; and
measuring cross-link interference reference signal receive power via the one or more resources based at least in part on the monitoring.

29. The method of claim 28, wherein the plurality of sounding reference signal resources correspond to communication sounding reference signal configuration, or a positioning sounding reference signal configuration, the one or more resources comprising a subset of the plurality of sounding reference signal resources.

30. The method of claim 28, wherein the plurality of sounding reference signal resources are allocated for the one or more cross-link interference measurements.
